(19) United States
(12) Patent Application Publication
(10) Pub. No.: US 2023/0242404 A1
(43) Pub. Date: Aug. 3, 2023

(54) FUNCTIONALIZED NANOSCALE DIAMONDS AND USES THEREOF

(71) Applicants: Institute of Organic Chemistry and Biochemistry of the CAS, v.v.i., Praha (CZ); San Jose State University Research Foundation, San Jose, CA (US)

(72) Inventors: Abraham Wolcott, Scotts Valley, CA (US); Petr Cigler, Prague (CZ)

(73) Assignee: San Jose State University Research Foundation, San Jose, CA (US)

(21) Appl. No.: 18/056,563

(22) Filed: Nov. 17, 2022

Related U.S. Application Data
(60) Provisional application No. 63/280,749, filed on Nov. 18, 2021.

(51) Int. Cl. C01B 32/28; C01B 32/26

(52) U.S. Cl. CPC C01B 32/28; C01B 32/26; C01P 2004/64

(57) ABSTRACT

Various aspects according to the instant published patent application relate to a functionalized nanoscale diamond. The functionalized nanoscale diamond includes a functionalized surface. The functionalized surface includes a brominated portion and a hydroxylated portion. In further aspects, the brominated portion can be reacted with an amine to form an aminated nanoscale diamond.

### CROSS-REFERENCE TO RELATED APPLICATION

This application claims the benefit of priority to U.S. Provisional Patent Application Ser. No. 63/280,749 entitled “FUNCTIONALIZED NANOSCALE DIAMONDS AND USES THEREOF,” filed Nov. 18, 2021, the disclosure of which is incorporated herein in its entirety by reference.

### BACKGROUND

Nanoscale diamonds, are diamonds with a size below 1 micrometer. They can be produced by impact events such as an explosion or meteoritic impacts. Because of their inexpensive, large-scale synthesis, potential for surface functionalization, and high biocompatibility, nanoscale diamonds are widely investigated as a potential material in biological and electronic applications and quantum engineering.

### SUMMARY OF THE INVENTION

Various aspects according to the instant published patent application relate to a functionalized nanoscale diamond. The functionalized nanoscale diamond includes a functionalized surface. The functionalized surface includes a brominated portion and a hydroxylated portion. In further aspects, the brominated portion can be reacted with an amine to form an aminated nanoscale diamond.

### BRIEF DESCRIPTION OF THE FIGURES

The drawings illustrate generally, by way of example, but not by way of limitation, various embodiments discussed in the present document.

FIG. 1 shows DRIFTS measurements of ND-Br samples exposed to air at 25° C. were tracked in situ from 0→60 minutes and showed a steady decrease in the (C—Br)_{ν} at 750 cm⁻¹.

FIG. 2 shows DRIFTS measurements of ND-Br samples exposed to air at 25° C. were tracked in situ from 0→60 minutes and showed a steady decrease in the (C—Br)_{ν} at 750 cm⁻¹.

FIG. 3 shows Pseudo first order reaction analysis of the fast debromination process in open-air conditions at 25° C. of various substances.

FIG. 4 shows Pseudo first order reaction analysis of the fast debromination process in open-air conditions at 25° C. of various substances.

FIG. 5 shows Pseudo first order reaction analysis of the fast debromination process in open-air conditions at 25° C. of various substances.

FIG. 6 shows Pseudo first order reaction analysis of the fast debromination process in open-air conditions at 25° C. of various substances.

FIG. 7 is a TPD-DRIFTS plot showing that the C—Br bond on the ND surface cleaved quickly at 90° C., reinforcing the lability and instability of the ND-Br constructs in inert atmosphere conditions.

FIG. 8 is a TPD-DRIFTS plot showing that the C—Br bond on the ND surface cleaved quickly at 90° C., reinforcing the lability and instability of the ND-Br constructs in inert atmosphere conditions.

FIG. 9 is a plot of the calculated distance (d) in nanometers of the C1s XPS signal attenuation and thickness of overlayers. The far right column estimates the length scales of the —OH, —Br and —NH₃ functional groups.

FIG. 10 is a survey scan of brominated (ND-Br) and aminated (ND-NH₂) ND samples used for quantitative analysis and atomic percentage calculations. Regions of analysis are outlined with dashed boxes.

FIG. 11 is a survey scan of brominated (ND-Br) and aminated (ND-NH₂) ND samples used for quantitative analysis and atomic percentage calculations. Regions of analysis are outlined with dashed boxes.

FIG. 12 is a survey scan of brominated (ND-Br) and aminated (ND-NH₂) ND samples used for quantitative analysis and atomic percentage calculations. Regions of analysis are outlined with dashed boxes.

FIG. 13 shows XAS data of silica coated NDs with amine functionalization using 3-amino-propyltrimethoxysilane or APS and after folic acid functionalization with sulfo-NHS/EDC coupling reagents

FIG. 14 shows XAS data of silica coated NDs with amine functionalization using 3-amino-propyltrimethoxysilane or APS and after folic acid functionalization with sulfo-NHS/EDC coupling reagents.

FIG. 15 is a graph showing electronic structure signatures of diamond were suppressed during the reaction of ND-Br and propargylamine due to a polymerization reaction leading to a core-shell structure.

FIG. 16 is a graph showing electronic structure signatures of diamond were suppressed during the reaction of ND-Br and propargylamine due to a polymerization reaction leading to a core-shell structure.

FIG. 17 is a graph showing electronic structure signatures of diamond were suppressed during the reaction of ND-Br and propargylamine due to a polymerization reaction leading to a core-shell structure.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99/0, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can itself be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphanyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon,” “hydrocarbyl,” or “hydrocarbylene,” as used herein, refers to a molecule or functional group that includes carbon and hydrogen atoms. The term can also refer to a molecule or functional group that normally includes both carbon and hydrogen atoms but wherein all the hydrogen atoms are substituted with other functional groups. A hydrocarbyl group can be a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are positive integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

According to various aspects of the present disclosure, a nanoscale diamond can be functionalized with an intermediate species that can lead to the formation of a carbocation that can be attacked by a nucleophile via an SN2 reaction to further functionalize the surface of the nanoscale diamond to ultimately affect the properties of the nanoscale diamond to be particularly suited for any number of uses. For example, diamond can be used in many industrial applications such as polishing and is also used in cutting-edge technology for magnetic and electric field sensing, quantum communication and biological labelling because of the nitrogen vacancy center (NVC) that is hosted within diamond. The use of NVC diamond in the bulk and nanoscale size regimes can be expanded when precise chemical control of the surface can be achieved.

Diamond is one of the most inert materials in existence and modifying its surface properties and forming new bonds are exceedingly difficult. Typical procedures for modifying the surface of diamond include plasma-based chemistry or high temperature chemistry that increases cost and prevents access to the use of certain protocols. Technology that allows for room temperature and solution-based processes to occur are highly attractive.

The generation of new bonds directly to the diamond lattice and in a homogenous fashion are energetically unfavorable due to the close packing of surface atoms, steric hindrance and the large bond strength of C—O bonds on the diamond surface. A solution to this problem is to produce a nanoscale diamond that comprises an activated surface.

The term nanoscale diamond refers to a diamond material that includes nanoscale dimensions. For example, the nanoscale diamond can have dimensions of about 1 nm to about 1,000 nm in length, about 1 nm to about 1,000 nm in height, and about 1 nm to about 1000 nm in thickness. The nanoscale diamond can be obtained through milling a natural or artificial diamond. For example, the nanoscale diamond can obtained by ball milling an artificial diamond.

Typical purification of nanoscale diamonds includes an oxidation procedure. The oxidation procedure typically results in functionalization of the surface of the nanoscale diamond with hydroxyl groups. Creating the activated surface, in turn, includes functionalizing at least a portion of the hydroxyl groups. Specifically, at least a portion of the hydroxyl groups can be functionalized with a bromine. Therefore, functionalization can include bromination. Bromination can occur using any suitable bromine-containing compound. For example, bromination can include contacting the hydroxyl groups with SOBr₂, thionyl bromide, or a mixture thereof. Brominating can occur in the absence of a catalyst. However, in some examples, bromination can occur with the aid of a catalyst. A suitable example of a catalyst is pyridine.

Following bromination, about 10% to about 50% (or about 20% to about 40%) of the total surface area of the nanoscale diamond is occupied by the bromine. Due to the stereochemistry considerations associated with bromine's size, it is not possible to react with each hydroxyl group on the surface of the nanoscale diamond. Thus, the hydroxyl groups can account for 10% to about 50% (or about 20% to about 40%) of the total surface area of the nanoscale diamond.

The brominated nanoscale diamond shows decent stability and the brominated nanoscale diamond can be stored at room temperature for a suitable amount of time. Due to the strong positive charge on the carbon bonded to the bromine, the carbon is particularly vulnerable to attack from a nucleophile. Suitable examples of nucleophiles can include amines which form a C—N bond, where the C is a surface carbon of the nanoscale diamond. For example, suitable amines can include NH₂, NHR¹, or NR¹R², where R¹ and R² are independently selected from substituted or unsubstituted (C₁-C₂₀)hydrocarbyl. An example of a specific amine that can be used for amination can include NH₃·THF. More specific nucleophiles can include propargylamine, diethylenetriamine, melamine, and polyethyleneimine.

The amination can occur via any suitable process. For example, the brominated nanoscale diamond can be immersed in the amine solution. Amination can occur at a temperature in a range of from about 20° C. to 50° C., about 20° C. to 30° C., or at room temperature (about 25° C.). Amination can occur with or without a catalyst. Following amination, the amine groups present on the surface of the nanoscale diamond can be modified via any suitable means to include any desirable functional groups or moieties.

The amines present on the surface of the nanoscale diamond, as well as any modifications to the amines, can determine the use or application of the aminated nanoscale diamond. Additionally, the presence of a nitrogen-vacancy (NV) center impacts the use or application of the aminated nanoscale diamond. As understood by one of ordinary skill, The nitrogen-vacancy center is a point defect in the diamond lattice. It includes a nearest-neighbor pair of a nitrogen atom, which substitutes for a carbon atom, and a lattice vacancy. Its most explored and useful property is its photoluminescence, which allows observers to read out its spin-state. The NV center's electron spin, localized at atomic scales, can be manipulated at room temperature by external factors such as magnetic, or electric fields, microwave radiation, or light, resulting in sharp resonances in the intensity of the photoluminescence. These resonances can be explained in terms of electron spin related phenomena such as quantum entanglement, spin-orbit interaction and Rabi oscillations, and analyzed using advanced quantum optics theory. An individual NV center can be used as a basic unit for a quantum computer.

The photoluminescence properties can make the aminated nanoscale diamond particularly useful as a probe. For example, the aminated nanoscale diamond can be deployed in a subject and its presence and/or location can be observed by toggling the electron-spin stated in the NV center. An additional application is to use the aminated nanoscale diamond in an optically detected magnetic resonance protocol. As understood by one of ordinary skill, optically detected magnetic resonance is a double resonance technique by which the electron spin state of a crystal defect may be optically pumped for spin initialization and readout.

### EXAMPLES

Various embodiments of the present invention can be better understood by reference to the following Examples, which are offered by way of illustration. The present invention is not limited to the Examples given herein.

### Example 1

Bromination of high-pressure high-temperature (HPHT) nanodiamond (e.g., nanoscale diamond) (ND) surfaces has not been explored and can open new avenues for increased chemical reactivity and diamond lattice covalent bond formation. Chemical routes can be expanded when diamond lattice-oxygen bonds are removed to attain a reactive diamond surface that is electrophilic and prone to nucleophilic attack. In this Example, tertiary alcohol-rich ND surface was transformed to a highly reactive alkyl bromide surface with ˜50% surface coverage, reaching a theoretical limit described by density functional theory. Alkyl-bromide moieties were observed to be highly labile on NDs and produce a long-lived carbocation or other reactive intermediate after debromination. The alkyl-bromide bond readily dissociates under open-air conditions and at 90° C. under inert conditions. The strong leaving group properties of the alkyl-bromide intermediate were found to form diamond-nitrogen bonds at room temperature and without catalysts. The chemical lability of the brominated ND surface led to efficient amination with NH₃·THF at 298 K, and a catalyst-free Sonogashira-type reaction with an alkyne-amine produced an 11-fold increase in amination. Overlapping spectroscopies under inert, temperature-dependent and open-air conditions provided unambiguous chemical assignments. Amide bond formation with amine-terminated NDs and folic acid was also demonstrated using sulfo-NHS/EDC coupling reagents, confirming that standard amine chemistry remains viable. This Example indicates that a robust pathway exists to activate a chemically inert diamond surface at room temperature, which broadens the pathways of bond formation when a reactive alkyl-bromide surface is prepared. These findings are impactful to researchers who wish to chemically tune diamond or ultradense material surfaces for quantum sensing applications with atomic defects such as the nitrogen vacancy center.

The addition of bromine to small molecules, macromolecules and carbon nanomaterials typically includes a bromine source such as Br₂, HBr or N-bromosuccinimide and can lead to bromine bonds with sp³- or sp²-hybridized carbon atoms. Bromine bound to carbon serves as a good leaving group and enables a catalog of reactions to be performed. Powerful demonstrations include Ullman coupling and Sonogashira reactions that use the enhanced leaving group properties of halogens in general and bromine in particular to form new chemical transformations. The synthesis of highly ordered nanoarchitectures with halogenated porphyrin rings takes advantage of the temperature-dependent dissociation of iodine and bromine to direct assembly on metal surfaces with a high level of fidelity. Bromine-functionalized graphene and carbon nanotubes have allowed robust chemical routes to be used for band engineering and sensing applications. In contrast, bromination on the surface of bulk diamond and detonation nanodiamonds (NDs) has not been widely explored—for good reason. Bromine has an atomic radius of 185 pm, which is large compared to the sterically hindered facet of the 111 diamond surface with 18 atoms/nm². For that reason, bromination of Si and Ge is more common due to the increase in crystal lattice spacing and decreased steric hindrance. One previous bromination protocol was used with detonation NDs and was not well detailed, and the handling was performed largely under open-air conditions and in the presence of water for purification. In this Example, the following is demonstrated: alkyl bromide formation on high-pressure high-temperature (HPHT) NDs is possible using thionyl bromide (SOBr₂), it displays enhanced chemical reactivity compared to that of brominated small molecule analogs and the reaction products must be carefully handled under inert conditions to retain alkyl bromide moieties. This Example addresses the difficulty in chemically activating HPHT ND surfaces, provides a new platform for atomic and molecular control and will be of interest to researchers using diamond and other ultrahard materials for quantum sensing applications.

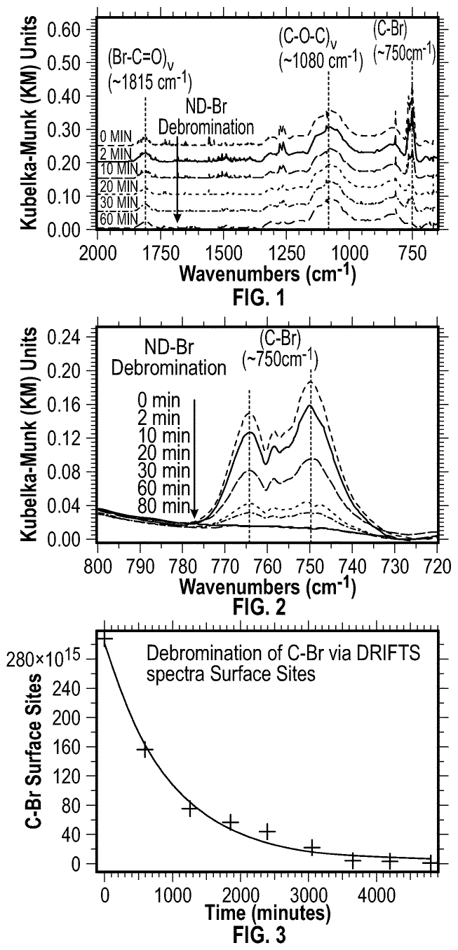

Understanding this work is based on the knowledge that open-air aerobic oxidation of HPHT ND powders results in alcohol (hydroxyl) groups terminating the surface in a fashion similar to that for bulk diamond on the {111} facet and not carboxylic acid termination as found on detonation NDs. Alcohol termination of bulk diamond is widely accepted within the diamond research community, but this fact has not been widely recognized by researchers studying HPHT NDs. This conclusion is supported by spectroscopic data (see FIGS. 1 and 2) and is rationalized by the understanding that the {111} facet is predominantly exposed in HPHT NDs due to ball milling. Similar to bulk diamond, {111} facets are single dangling bond surfaces and may form one sp³-hybridized bond per surface carbon atom. Confusion exists regarding the assumption that HPHT and detonation NDs have the same surface structure after aerobic oxidation, which is not supported by spectroscopic data. The differences between HPHT and detonation NDs are a result of the production method, their resultant surface-to-volume ratio and exposed crystallographic facets. HPHT NDs of 30-100 nm are produced in a top-down approach through ball milling of bulk single-crystal diamonds by manufacturers such as Microdiamant (Switzerland) and are commercially sold for polishing applications. Ball milling predominantly cleaves the {111} crystallographic planes based on facet strength and in turn exposes the single dangling bond surface. The dangling sp³ bond can then support alcohol bond formation during aerobic oxidation, as seen in bulk 111 terminated diamond. In handling bulk diamond, a jeweler cleaves a rough diamond stone along the (111) direction to produce a well-cleaved diamond, and this phenomenon has been empirically known for centuries. Density functional theory (DFT) calculations by Telling clearly showed that diamond cleavage proceeds as a function of strain from {111}→{110}→{100} with maximum strengths of 90 GPa, 130 GPa and 225 GPa, respectively, and is caused by strength anisotropy. Electron microscopy of 30-100 nm HPHT NDs has verified the cleavage process, with irregularly shaped particles that resemble shards of broken crystallites. In contrast, detonation NDs are produced through a bottom-up approach wherein hexogen or trinitrotoluene (TNT) is ignited in stainless steel vessels, resulting in faceted spherical particles with diameters of ˜5 nm. Detonation NDs have a larger surface area (270-315 m²/g) than HPHT NDs (57-140 m²/mg), a diverse range of carbon-oxygen moieties from ethers to acid anhydrides and a high concentration of sp² groups formed by dangling bonds, as confirmed via Raman spectroscopy.

In most settings where surface control is required, HPHT NDs (ranging from 30-100 nm) are aerobically oxidized to remove amorphous carbon from the surface and produce an alcohol-rich surface. Chemical modification of the tertiary alcohol surface is a critical step for the construction of functional sensors using nitrogen vacancy centers (NVCs) or as a catalytic substrate, but modifying or removing the C—O—H bonds is challenging. The difficulty in modifying oxidized diamond surfaces is due to the large carbon-oxygen bond dissociation energies (1442 kJ/mol), high atomic surface density (18.2 atoms/nm² on the 111 facet) and steric hindrance. In contrast, chemical modifications of detonation NDs typically target surface carboxylate groups via amidic coupling or reactive sp² structures, which can be created by thermal annealing of detonation NDs. Much work has been accomplished with the more reactive 5 nm detonation materials and has been reviewed thoroughly. Oxidized HPHT NDs have properties analogous to those of bulk diamond and have been thoroughly studied using multiple surface sensitive techniques. The conversion of tertiary alcohols to carboxylic acids with acid-base-acid chemistry is widely known and provides a pathway for surface linking chemistry; however, the surface density of carboxylic acids can reach only a few percent of the surface carbon atoms and is inhomogeneous. Growth of silica (SiO₂) shells on ND cores is a demonstrated route for chemical modification of HPHT NDs, and background-free cellular imaging, real-time magnetic sensing and coating with tailored lipidic bilayers have been demonstrated. With silica shell growth, the carbon-oxygen groups are not removed from the diamond surface but instead used to form a priming layer to generate silica growth in a modified Stöber method.

For long-term advancements with HPHT NDs and other ultradense materials such as silicon carbide, these Examples are relevant because we activate the inert carbon-oxygen bond and produce a reactive surface intermediate that is exploited for carbon-heteroatom bond formation. Direct amine bond formation of HPHT NDs has not been demonstrated previously and is a clear demonstration of a useful surface termination approach for biolabeling applications due to the enhanced reactivity of amines. Previously, direct bulk diamond lattice-nitrogen bond formation is limited; for example, Stacey and coworkers used nitrogen-rich plasma treatment to terminate (001) diamond surfaces and produced a N—N-rich surface. Although these surfaces are expected to induce a positive electron affinity, they leave behind minimal surface states within the bandgap and allow the near-surface carbon atoms to exhibit bulk-like electronic states.

Here, we demonstrate that room temperature and catalysis-free diamond lattice-to-nitrogen bond formation of aerobically oxidized HPHT NDs is possible through a highly labile alkyl bromide intermediate. Surface analysis of the NDs revealed that ˜50% of the surface carbon atoms were brominated, achieving an upper limit previously described by DFT. The Examples describe a reaction pathway that chemically activates the alcohol-rich nanodiamond surface (ND-OH), converting the alcohol groups to alkyl bromides; moreover, it was found that the brominated HPHT ND surfaces have enhanced reactivity and that debromination occurs within seconds under open-air conditions and at 90° C. under inert conditions. Debromination under open-air conditions did not yield new alcohol groups, suggesting that a long-lived carbocation or other intermediate is present at the ND surface. Generating amine bonds on the diamond lattice is motivated by the enhanced reactivity of amines in comparison to alcohols and the vast library of chemical modifications based on amines. Conjugation of ND-NH₃ with folic acid to form amide bonds was performed, which established that reaction of these amine groups with small molecules was successful. By using mild nucleophiles (amines), the Examples show that reactions with ND-Br under conditions at 25° C. and without catalysts are possible. Additionally, a reaction of ND-Br and propargylamine yielded a polyimine-coated ND core via a Sonogashira-type reaction and an 11-fold increase in the nitrogen content. With these reactive ND-Br constructs, researchers in chemistry, bioengineering and materials science could use a catalogue of nucleophiles to generate new diamond-heteroatom bonds. Robust chemical and electronic structure analysis of the NDs using overlapping spectroscopic techniques under inert, temperature-dependent and open-air conditions provided definitive characterization. This new surface pathway will likely be impactful for researchers using nanoscale diamonds with nitrogen vacancy centers (NVCs) for biolabeling, quantum sensing and quantum communication applications.

Hydrophilic ND-OH surface and water desorption via TPD-DRIFTS. Spectroscopic features of aerobically oxidized ND-OH can yield important information about hydrophilicity/hydrophobicity and the preparation of ND constructs for bromination chemistry. Aerobic oxidation of HPHT NDs rendered the 30-50 nm ND-OH particles hydrophilic and tannish in color after removal of dark amorphous carbon. Diffuse reflectance infrared Fourier transform spectroscopy (DRIFTS) provided surface vibrational modes of the ND-OH samples under open-air, inert atmosphere and temperature-dependent conditions. ND-OH samples have a pronounced peak at 1105 cm⁻¹ assigned to the (C—O)_{ν} band of tertiary alcohols, the bending mode of adsorbed water (O—H)_{δ} at ˜1630 cm⁻¹, a carboxylic acid peak at 1780 cm⁻¹ and a broad O—H stretching band (O—H)_{ν} at 3000-3500 cm⁻¹ due to adsorbed water and alcohol groups (FIG. 1). Using Kubelka-Munk transforms, it was estimated that there are ˜30:1 alcohol groups for each carboxylic acid observed after oxidation at 525° C. for 5 hours, and this ratio can be estimated via integration and the available extinction coefficients of tertiary alcohols and carboxylic acids from NIST. Previous work on HPHT NDs mistakenly assigned the 1630 cm⁻¹ peak to C═O-containing groups such as ketones, and we wished to clarify that this feature is not due to oxygen-terminated diamond. It was confirmed the adsorbed water spectral component via temperature programmed desorption (TPD)-DRIFTS at 25, 100, 200 and 300° C. under open-air conditions. The observed water stretching band and bending mode simultaneously decreased as expected when water left the surface, and the stretching modes of (C—O)_{ν} and (C═O)_{ν} on the ND-OH surface remained (FIG. 1). The quantitative removal of adsorbed water was found to be 72%, 97% and 100% at 100° C., 200° C. and 300° C., respectively. Here, the 1630 cm⁻¹ peak was used as a quantifiable signature for the dryness of our samples prior to bromination chemistry with SOBr₂. During DRIFTS data collection, the observation of the adsorbed water band is a key metric in determining the hydrophilicity, hydrophobicity and water content during bromination and amination reactions. The materials and procedures of all samples show ND-OH, ND-Br and ND-NH₃ sample preparation.

Synthesis and characterization of ND-Br. The conversion of ND-OH (tertiary alcohols) to ND-Br (alkyl-bromide terminated) constructs was accomplished with SOBr₂ at room temperature, wherein the diamond lattice bromine bond is likely formed via an S_{N}1 (substitution type 1) mechanism and the addition of pyridine increases the rate. ND-Br formation was confirmed with a strong doublet peak arising at 750 cm⁻¹ due to the (C—Br)_{ν} stretching mode (FIG. 2), which was in a region that was vibrationally silent in ND-OH. Mechanistically, ND-Br reactions with SOBr₂ proceed via a bromosulfite ether intermediate, a release of bromide ions via pyridine nucleophilic attack and finally carbocation intermediate formation, resulting in nucleophilic attack by Br⁻ on the diamond surface. Bromination of diamond with an S_{N}2 (substitution type 2) mechanism would not be possible due to the saturation of all carbon-carbon bonds in the diamond subsurface and therefore should follow an S_{N}1 mechanism during bromination with a carbocation intermediate. The mechanism is hypothetical and depicts the most likely route for bromination. ND-Br bond formation proceeded without pyridine within 24 hours, with easier purification and a lower C—Br yield. The use of pyridine produced a viscous side product of pyridinium perbromide (NC₅H₅·HBr·Br₂), which was removed with a dimethyl sulfoxide (DMSO) washing step. An increased rate of ND-Br formation with pyridine was observed when comparing 2-hour and 24-hour reactions and tracking the emergence of the (C—Br)_{ν} stretching mode at 750 cm⁻¹ The champion ND-Br sample was produced after only a single washing step and remained stable for 24 hours, and the (C—Br)_{ν} signal at 750 cm⁻¹ dominated the spectra. The champion ND-Br sample lacks reproducibility due to instability associated with an increased level of bromination, which is under investigation.

There is evidence of a unique intracrystallite Williamson ether-like reaction occurring as a byproduct of the reaction of alkyl bromides and alcohols adjacent to one another on the diamond surface. Significant surface features are modified after the bromination reaction, including complete removal of the (O—H)_{ν} band at 3000-3500 cm⁻¹ from adsorbed water and removal of alcohol groups. While desorption of water was predicted due to desiccating the sample prior to bromination, the elimination of alcohol (C—O—H) groups was unexpected and suggested that ether functionalities (C—O—C) were formed during the SOBr₂ treatment through a substitution reaction. The formation of ethers is traditionally understood to proceed by an intramolecular Williamson-type ether rearrangement whereby an alkoxide reacts with an alkyl halide to yield an ether through an S_{N}2 reaction mechanism, yet an S_{N}2 reaction would not be possible with diamond due to sterics. Based on that understanding, ether bridges would be formed by adjacent alcohols reacting with nearest neighbor alkyl bromides along with the formation of HBr. The evidence includes the emergence of a peak at ˜1025 cm⁻¹ after bromination, which we assign to the (C—O—C)_{ν} stretching mode and lack of (O—H)_{ν} signal from alcohols at ˜3200 cm⁻¹.

### Confirmation of Alkyl Bromides and Surface Coverage.

X-ray photoelectron spectroscopy (XPS), a surface-sensitive and element-specific technique with a 1.7-2 nm probe depth, confirmed the transition from an alcohol-rich surface to an alkyl bromide-terminated surface, in agreement with our DRIFTS results. An inert transfer module was used for all XPS data to ensure the retention of alkyl-bromide termination and eliminate H₂O and O₂ exposure. The C1s XPS data of ND-OH showed peaks at 284.5 eV, 286.5 eV and 288.5 eV, which were assigned to bulk diamond (C—C), alcohols (C—O) and carboxylic acids (COOH), respectively (FIG. 3). Previous quantitative analysis has shown the alcohol-to-carboxylate ratio to be ˜15:1, suggesting that SOBr₂ reacts primarily with hydroxyl moieties on the diamond surface, in agreement with the DRIFTS results. ND-OH treated with SOBr₂ produced an ND-Br construct that exhibited convolved features attributable to the (C—C), (C—Br) and (C—O) bonding environments at 284.5 eV, 286.0 eV and 286.5 eV, respectively. The results were interpreted as being consistent with a partially brominated surface that retains either alcohol or ether moieties due to the intracrystallite Williamson ether-like reaction. Br3d XPS spectra showed evidence of alkyl bromide formation with convolution of the Br3d_{3/2} and Br3d_{5/2} spin states at 70.0 eV and 69.0 eV, respectively, with an energy difference of ˜1.0 eV and a ratio of 0.6 eV. Pyridine addition with SOBr₂ stopped after 2- and 24-hour reaction times increased the bromination efficiency in comparison to the uncatalyzed bromination protocol (FIGS. 1 and 3). The addition of pyridine plays two active roles: harvesting protons generated during the nucleophilic attack of the alcohol moiety on the sulfur center and activating the release of bromide ions from the intermediate bromosulfite ester complex bound to the diamond surface. The XPS and DRIFTS data indicate that the rate of alkyl bromide formation increased by ˜60% over the course of the reaction with pyridine.

The quantification of surface groups is based on a model in which all C1s XPS signals are from diamond with an inelastic mean free path of approximately 1.87 nm and where the N1s, O1s and Br3d signals originate from surface moieties. Based on analysis of the XPS survey scans, inelastic mean free electron escape depths of C, N, O and Br photoelectrons and their respective ionization cross sections, we estimate that 36-52% of all surface sites were brominated in examining 3 different samples. Br3d XPS data of ND-Br samples were originally underestimated due to spontaneous debromination after synthesis and debromination under ultrahigh vacuum conditions. A typical survey scan with a Tougaard background of ND-Br showed C1s, O1s and Br3d atomic percentages of 73%, 23.5% and 2.5%, respectively. When modeling the surface termination with a 111 facet (18.2 atoms/nm²), It was calculated that ˜3 C—Br bonds/nm² were formed, and without the addition of pyridine, the bromination reached ˜0.5% or 0.6 C—Br bonds/nm². These bromination rates were revised when considering the yield of C—N bond formation that occurs after successful bromination. Based on the nitrogen atomic percentage of 5.4-7.8% after amination chemistry and a 1:1 alkyl-bromide→amine mechanism, it was concluded that Br levels of 36-52% were achieved (Tables 2 and 3). The bromination of 36-52% of the surface sites reached the maximum of 50%, yet the DFT calculations did not account for the intracrystallite surface chemistry of the Williamson ether-like reaction, which decreased the bromination yield. Previous DFT calculations showed that the addition of bromine atoms to a clean C-terminated (001)-(2×1) surface at 50% coverage had an adsorption energy of 1.82 eV/atom, which was lower than that for the addition of hydrogen, fluorine and chlorine across a (111)-(1×1) surface, with 2.17 eV/atom, 4.72 eV/atom and 2.22 eV/atom, respectively. Lower bromination rates are predicted in comparison to those with hydrogen, fluorine and chlorine due to the large atomic radii of bromine. Bromine has a lower electronegativity than that of chlorine and DFT studies theoretically support our experimental findings. Alternative bromination routes can potentially yield 50% or above, but the hypothesis is that alcohols should be removed prior to bromination chemistry to prevent ether formation and steric hindrance, while lower temperatures should be employed (T<10° C.) during the purification and storage protocols to inhibit instantaneous debromination.

### Diamond-Bromine Bond Dissociation Studies in Open Air.

The ND-Br samples exposed to air resulted in fast alkyl-bromide dissociation, representing potential evidence of a long-lived carbocation. The ND-Br surface is extremely labile in comparison to that of many brominated substrates, including 1-bromoadamantane. Instantaneous debromination of ND-Br under open-air conditions at 25° C. was tracked with DRIFTS and showed a t_{1/2} value of ˜12 minutes when diffusion of air was allowed into the inert atmosphere of the DRIFTS chamber. Alkyl bromide dissociation was found to have pseudo-first-order kinetics of k′=7.67*10⁻⁷l/s based on the local relative humidity at the time of the experiments. During the 80-minute experiment, there was no evidence that the diamond surface formed new alcohols, as no increase in the 1105 cm⁻¹ peak was observed. Notably, the (Br—C═O)_{ν} mode at 1815 cm⁻¹, which shifted 35 cm⁻¹ from its nominal (C═O)_{ν} position, did not change during the air exposure study. We hypothesize that sterically unhindered acid bromides at edges and defect sites are more stable than alkyl bromides. Alkyl bromides are sterically hindered and energetically destabilizing on the diamond facets as calculated by DFT; therefore, acid bromides did not readily undergo debromination during these experiments.

The observations based on DRIFTS suggest that a long-lived carbocation or other chemically active intermediate on the ND surface may exist, persisting for 80 minutes or longer at 25° C. Calculations showed a surface bond angle of 112.9° that was interpreted as having sp² character and described as a “radical carbon.” The findings were interpreted as a conformation of this unique bonding environment found on brominated diamond. For small molecules, an analogous system would be that of 8,9-dehydro-2-adamantyl with a stable carbocation at −120° C., as confirmed via ¹H and ¹³C nuclear magnetic resonance (NMR) spectroscopy. However, tracking carbocations with solution or solid-state NMR techniques is not possible due to the lack of sensitivity of NMR spectroscopy to trace surface groups on HPHT ND surfaces. The lability of the C—Br bond, the unique properties of diamond and the low concentration of water molecules under atmospheric conditions have aided this finding. Based on these observations and analysis, the conclusion is that rehydroxylation is slow compared to the debromination kinetics at 60% relative humidity and 25° C. To test the reactivity of ND-Br, we reacted the ND-Br samples with 18 MΩ water [55.5 M] for 1 minute, purified by centrifugation and probed with DRIFTS and found the reemergence of an alcohol-rich surface within the 1-minute reaction time. The pseudo-first-order rate was k′=0.055 l/s with neat water, an increase of 7.2*10⁴ in reaction rate, and we calculated that the rehydroxylation reaction is complete in approximately 66 ms under these conditions.

### Direct Catalyst-Free Amine Formation at Room Temperature.

Demonstration of amine insertion via nucleophilic attack of the alkyl-bromide functionalized diamond was accomplished at room temperature using ammonium in tetrahydrofuran (NH₃·THF) in anhydrous dichloromethane (DCM) and was found to convert all brominated surface species. The use of NH₃·THF is rationalized to ensure that all XPS and X-ray absorption spectroscopy (XAS) spectroscopic signatures for carbon-nitrogen bond formation are a result of new amine moieties. ND-NH₃ inner-shell chemistry (covalent bonds directly with the diamond lattice) was verified via laboratory and synchrotron-based surface sensitive spectroscopies, as we show with the following evidence. DRIFTS spectra showed that the (C—Br)_{ν} stretching modes at 750 cm⁻¹ were completely removed, and new peaks related to amine functionalization appeared at 1025 cm⁻¹ and 820 cm⁻¹, corresponding to (C—N)_{ν} and (N—H)_{wag} modes, respectively (FIG. 2B). An unambiguous conversion from a hydrophobic ND-Br surface to a hydrophilic ND-NH₃ surface after amination chemistry was evident through the large intensity increase in both the (O—H)_{ν} and (O—H)_{δ} modes of adsorbed water observed at 3000-3500 cm⁻¹ and 1630 cm⁻¹, respectively. When comparing ND-OH versus ND-NH₃, the adsorbed water signals increase, and we conclude that the is hydrophilicity qualitatively increased when amine termination is present at 36-52% surface coverage. The colloidal solutions of ND-NH₃ were stored in 18 MΩ water prior to further analysis, and conjugation to folic acid via N-hydroxysulfosuccinimide/1-ethyl-3-(3-dimethylaminopropyl)carbodiimide (sulfo-NHS/EDC) coupling is described in the procedures and materials section.

Ambiguity in assigning peaks with DRIFTS is common, and XPS allowed for a definitive confirmation of C—N bond formation after NH₃·THF chemical treatments. We found that successful amine bond formation was a function of C—Br density (catalyzed and uncatalyzed ND-Br) on the ND surface, as observed in FIG. 3B, whereby the N1s photoemission spectra show enhanced C—N resonance at 400.3 eV and a minor C═N feature at 402.6 eV, consistent with amination of diamond films with NH₃ plasma and CN thin films.^{46,60} The C1s photoemission peaks after amination chemistry also show a deconvolved C—N resonance at 286.0 eV, C—C resonance at 284.8 eV and contributions from C—O and C═O at 286.5 eV and 288.0 eV, respectively. Based on the XPS atomic % results, we conclude that the conversion of ND-Br→ND-NH₂ is quantitative, with a typical survey scan showing C1s, O1s and N1s percentages of 69.4%, 22.8% and 7.8%, respectively. The exchange of a Br3d signal at ˜2.5% to a N1s signal at ˜7.8% is suggestive of a complete S_{N}1 or E1 nucleophilic substitution by NH₃·THF under anhydrous conditions. We estimate that 36-52% of surface carbon atoms were aminated, which translates to 6.5-9.5 amines/nm². The disparity in the Br3d:N1s signal is due to instantaneous debromination under ultrahigh vacuum conditions, as mentioned previously. No signals from Br3d remained in either survey scans or high-resolution scans after the amination and purification steps. The rate of C—N bond formation is limited to the concentration of C—Br bonds on the surface, and we conclude that catalyst-free amine bond formation is a consequence of the dissociation of alkyl bromides and the long-lived carbocation intermediate that was observed using DRIFTS under open-air conditions.

### Soft X-Ray Spectroscopy of ND-OH, ND-Br and ND-NH₃.

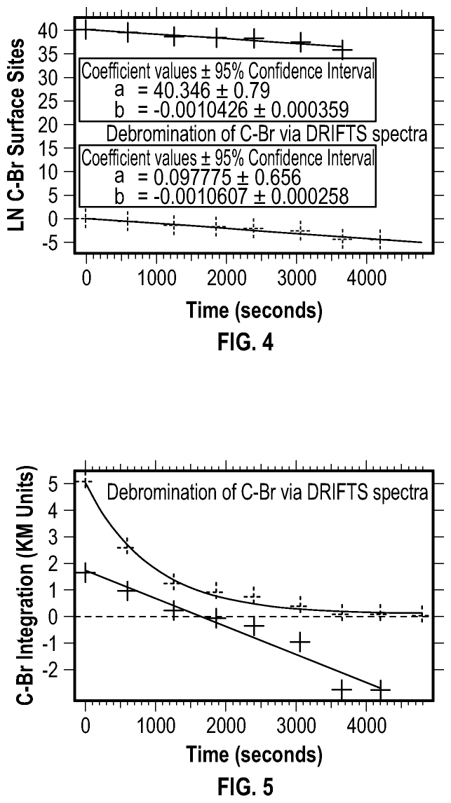

XAS measurements of NDs are essential in this work because they provide simultaneous conformation of the presence of diamond (core-hole exciton and 2nd absolute bandgap) while examining the surface termination of nitrogen or oxygen moieties independently (FIG. 4). XAS is an element-specific spectroscopy technique that provides information on the electronic structure of molecules and solids, including the chemical state, bond order, bond length and orientation of adsorbates. In the soft X-ray regime, when collecting in total electron yield (TEY) mode, TEY provides surface and bulk information with a mean probing depth of approximately 5-10 nm. FIG. 4A shows the C1s XAS spectra for ND-OH and the characteristic features of bulk diamond; we observe little sp²-like carbon near 285 eV, a strong sp³ core-hole exciton peak at 289.0 eV and a 2^{nd} absolute bandgap at 302 eV.^{62,63} The C1s spectra of ND-OH have weak signals associated with π*_{(C═C)} (approximately 285.3 eV) due to amorphous carbon and carbonyl (π*_{(C═O)} transitions, covering 286.5-288 eV) prior to the large core-hole exciton peak at 289.0 eV. After bromination, ND-Br shows new features in the 286-288.5 eV region with strong resonances at 287.2 eV and 288.4 eV and is assigned to the σ*_{(C—Br)} electronic states due to unoccupied Br p-orbitals bound to the diamond surface. The origin of these new C1s features can be understood by the unoccupied Br p-orbital states as described by Tiwari et al. The amplitude of the carbon-bromine resonances is increased for a surface species in TEY mode and is due to the larger photon absorption cross section of the 1s→p transitions of brominated diamond. O1s data for ND-OH are dominated by the σ*_{(C—O)} at 540 eV due to alcohols and small π*_{(C═O)} transitions due to carboxylates at 534 eV. After bromination, minor O1s features arise at 532 eV and 542-550 eV due to π*_{(Br═O)} and σ*_{(O—Br)} and resonances, respectively. Due to the atomically dense diamond surface, we consider that both alkyl bromides and different carbon-oxygen-bromine bonding environments may exist simultaneously.

N1s XAS presents key signatures of C—N, C═N and N—H bond formation after catalyst-free amination chemistry at room temperature. Challenges exist in performing N1s XAS on diamond due to the large C1s background at high energy (380-420 eV) that the N1s near-edge features are convolved with. First, a low energy resonance was assigned at 398.5 eV to the π_{(N—C═O)} of a carboxyamide and reinforce this assignment by probing a control sample. An amide was prepared with a silica-coated ND functionalized with amines (3-aminopropyl-trimethoxysilane, i.e., APTES), conjugated to folic acid via sulfo-NHS/EDC coupling and produced a strong π*_{(N—C═O)} peak at 398.2 eV. The feature at 398.5 eV is assigned to a carboxyamide on the ND surface and has enhanced π-character due to the nitrogen lone pair delocalization with the carbonyl. Low-energy N1s peaks (398-400 eV) are typically assigned to 1s→π* transitions, and the presence of C═N features has been observed in 6-ring heterocycles such as cytosine and pyrazinecarboxamide. The findings are consistent with Graf et al., who studied APTES on silica and assigned N1s signals at ˜388 eV to π*_{(C═N)} due to radiation damage-induced deprotonation, and similar features were observed. The feature at 400.5 eV is assigned to the σ*_{(N—H)} of a primary or secondary amine and is consistent across amination with NH₃·THF-, hydrazine- and folic acid-conjugated samples. The higher energy features at 404.8 eV and 407.6 eV are assigned to the σ*_{(C—N)} bonding environment. ND-NH₂ 1s→σ* transitions are due to a primary amine C—N and possibly a C—N—C bridging configuration similar to a secondary amine. When ND-NH₂ is conjugated to folic acid and amide bond formation occurs, several key features change as the nitrogen lone-pair electrons contribute to the delocalized bonding environment. The π*_{(C—N)} resonance at 398.5 eV increases in intensity, σ*_{(N—H)} remains at 400.5 eV, σ*_{(C—N)} peak becomes a broadened peak at 407 eV, and double peaks are no longer present. These assignments are reinforced by the control experiments with amine-functionalized silica bound to folic acid, and the conversion is evident.

### Transition Edge Sensor, RIXS, PFY-XAS and XES.

The transition edge sensor (TES) detector housed at beamline 10-1 at the Stanford Synchrotron Radiation Lightsource (SSRL) provides background-free X-ray emission data and electronic structure information of the valence (occupied) band structure of nanoscale diamond and surface moieties and aids analysis of noncarbon surface species. Emission data shows that after amination chemistry performed at −77° C., 25° C. and 600° C. with condensed NH₃, NH₃·THF and gaseous NH₃, respectively. C Kα X-ray emission was consistent with past studies of diamond, with bandgap emission beginning at ˜284 eV and extending to 250 eV. The C Kα emission features above the bandgap (289-312 eV) are different for each ND-NH₂ construct and are potentially due to vibronic coupling to the diamond lattice, surface moieties or Rayleigh scattering. Importantly, the N Kα emission data are unique in intensity for each of the chemistries used, extend from 365-440 eV and include both X-ray emission features and Rayleigh scattering. Because XAS/X-ray emission spectroscopy (XES) data of aminated diamond are scarce, we compare our spectra with model systems of ammonia and N-doped graphene. Standard NH₃·THF chemistry of ND-Br constructs yielded 3 distinct regions of emission from 380-402 eV (region A), 408-420 eV (region B) and 420-440 eV (region C). The last two regions show step-like emission and are due to Rayleigh scattering and participator emission, respectively. Chemical treatment of ND-Br with NH₃·THF at 25° C. yields amination rates similar to those of NH₃ gas at 600° C., yet the mechanism is expected to be different due to temperature-dependent debromination and surface reconstruction. Nucleophilic addition of NH₃ to the tertiary carbocation on the diamond surface at 25° C. should proceed as depicted in with production of an HBr side product. NH₃ gas chemistry at 600° C. should proceed through thermal debromination at temperatures above 25° C., desorption of alcohol groups above 500° C. and Pandey reconstruction of the diamond surface.

XES spectra was modeled focusing on the dominant C—N and N—H occupied density of states and compare the spectra to ammonia and glycine. NH₃·THF treatment yielded a dominant spectator N Kα peak at 398.3 eV, which is assigned to the lone pair electrons on nitrogen or C—N bonds and is supported by similar XES features in glycine and DFT calculations of the highest occupied molecular orbital (HOMO) isodensity surfaces. The 402.5 eV peak is assigned to the N—H HOMO orbitals and is very close to a resonant excitation of the σ*_{(N—H)} transition. The lower energy tail from 380-393 eV is assigned to a mixture of delocalized HOMO states described as HOMO-8/9/10. StoBe-DeMon has been used to calculate the transition probabilities based on the ground state Kohn-Sham eigenstates, which accurately calculated the XES spectra of glycine, diglycine and triglycine. Gas-phase amination chemistry using NH₃/N₂ mixtures at 600° C. produced similar features at 398.3 eV (lone pair electrons amines/C—N) and 402.5 eV (N—H) with reduced intensity in comparison to that for the NH₃·THF treatments. A new feature arose at 393.7 eV, which was assigned to HOMOs of imides (C═N), consistent with increased π*_{(C═N)} XAS transitions at 399.5 eV (data not shown). At temperatures above 500° C., tertiary bromides and alcohols desorb and produce sp²-like Pandey chains due to uncoordinated surface sites, and nitrogen insertion is likely to occur. In the presence of gaseous NH₃ at high temperatures, competitive kinetics exist for thermal desorption, surface reconstruction and new amine/imide bond formation. In situ studies using high-temperature DRIFTS in an NH₃ environment are planned to elucidate the kinetic pathways. Amination chemistry at −77° C. with liquid ammonia only showed N Kα features representative of spectator emission, with an asymmetric peak from 380-407 eV. The lower kinetic rate of amination and shorter reaction time of 30 minutes resulted in less C—N bond formation but did highlight that catalyst-free bond formation occurred at −77° C.

Propargyl Amine Reacted with ND-Br.

In a demonstration of an uncatalyzed Sonogashira-type coupling reaction,⁷⁴ ND-Br was reacted at 25° C. with propargyl amine (PA), an alkyne, and produced an 11-fold increase in the nitrogen signal in comparison to that of other ND-NH₂ constructs (FIG. 5B/C)). The original intent of the PA reaction was to form a new C—N surface bond with an outward facing alkyne for click chemistry, yet the reaction did not proceed in that fashion. A resonant inelastic X-ray scattering (RIXS) map details both the occupied and unoccupied electronic structures of the PA-reacted ND samples (FIG. 5B). The RIXS map was generated by scanning the X-ray monochromator (excitation energy on the y-axis) and recording the emitted X-rays using the TES detector. The linear feature marked “R” is the Rayleigh scattering of the incident X-rays and is a common feature in RIXS. The RIXS map details a high reactivity level between ND-Br and PA without a metal-based catalyst. Our findings are similar to the uncatalyzed reaction of a brominated precursor and an alkyne by Liu and Li using UV irradiation, which proceeded through a carbocation intermediate. Partial fluorescence yield (PYF) XAS reveals this increase in nitrogen content of the ND-NH₃ samples compared to other amination routes (FIG. 5C). The PFY-XAS data are produced by integrating the emission intensity as a function of excitation photon energy, are complimentary to traditional XAS and eliminate the high energy background signal of carbon. PFY-XAS peaks at 398.3 eV, a shoulder at 401.0 eV and a broad resonance at 406.2 eV are assigned to the π*_{(C═N)}, σ*_{(N—H)} and σ*_{(C—N)} resonances, respectively. The sharp and intense π*_{(C—N)} feature is evidence that PA polymerized on the ND surface, as expounded below.

N Kα emissions from PA-treated samples have much higher count rates than single carbon-nitrogen bonds on the ND surface with NH₃·THF or NH_{3(condensed or gas)} chemistry and are evidence of polymerization. Comparison of the N Kα resonant X-ray emission (RXES-blue trace) and nonresonant X-ray emission (NRXES-purple trace) of ND-PA differ in the intense emission at 396.8 eV for the RXES overlapping with the Rayleigh scattering line (marked R) and the lower energy peak positions from 391-392 eV. RXES data were produced by integrating emission counts from 397-400 eV excitation energies (white box in FIG. 5B), while NRXES data were obtained by integrating from 410-440 eV. The RXES and NRXES peaks are redshifted 1.5 eV and 6.3 eV from the C═N resonance at 398.3 eV, respectively. The RXES peak that overlaps with the Rayleigh line is due to either vibronic coupling or a large overlap between the electron wave function and core hole produced by the exciton, leading to higher emission rates, as observed previously with NH₃ and ND₃. The vibrational fine structure of the ND-PA sample was not observed in this study. The integrated XES signals (solid traces) of NH₃·THF, NH₃ gas at 300° C. and folic acid-conjugated NDs are included for comparison and are dominated by Rayleigh scattering. These results are consistent with reactions and polymerizations of aminoalkynes with transition metal catalysts and yield imines and enamines. Because there is a minor π_{*(C═C)} resonance observed in the PA reaction, we conclude that a polyimine, not enamine, is the dominant reaction product.

Importantly, the C is XAS of ND-PA samples does not show the core-hole exciton and 2nd bandgap of diamond and is due to a shell of PA formed on the ND core via polymerization. The suppression of the core-hole exciton in conjunction with the intense nitrogen signal, clear π*_{(C═N)} PYF-XAS signatures caused by imines and σ*_{(C—N)} N1s PFY-XAS resonance reinforces that multiple layers of reacted PA reside on the ND surface. We propose two possible mechanisms in which the alkyne or amine reacts with the carbocation after debromination and continues to polymerize in the presence of HBr. A control reaction of ND-Br with N-Boc PA yielded low amination rates, and the presence of the diamond electronic structure was observed (data not shown), supporting the polymerization reaction. This Sonogashira-like reaction has not been reported on ND surfaces and highlights the level of reactivity of ND-Br under mild conditions and in the absence of a metal cocatalyst. Future studies can attempt to control the growth of the PA shell by stopping the reactions at various time intervals and characterizing the ND constructs.

In summary, it was realized the first bromination and subsequent amination of HPHT ND, provided detailed observations of the diamond-bromine bond and realized subsequent carbon-nitrogen bond formation at 25° C. without the use of catalysts. The formation of tertiary alkyl bromides was found to be very labile and sensitive to water and resulted in Williamson ether-like surface reconstruction. The bromination rates were found to be 36-52% of the available surface carbon atoms based on XPS analysis and were near the predicted value of 50% surface coverage based on DFT. The lability of the carbon-bromine bond on diamond has been confirmed experimentally here, and this bond is highly unstable compared to that in brominated small molecule analogs. Uncatalyzed carbon-nitrogen bond formation is understood by the good leaving group properties of ND-Br, readily forming a carbocation or other reactive intermediate that subsequently leads to covalent amine termination. As a proof of concept relevant for biolabeling with NV diamond, we conjugated folic acid to ND-NH₃ constructs and found evidence of amide bond formation. The use of synchrotron spectroscopy and the TES detector allowed detailed examination of the occupied and unoccupied electronic states of the ND constructs, and we found that propargylamine reacted with ND-Br to yield polyimines in an uncatalyzed Sonogashira-type reaction. This work is impactful for researchers who wish to explore heteroatom chemistry on diamond and other ultrahard, ultra-dense materials (e.g., silicon carbide or boron carbide). Furthermore, we envision researchers using HPHT NDs for quantum sensing or as a source of free electrons for wet chemistry will find these discoveries impactful.

### Example 2

### Materials and Procedures

High-pressure high-temperature nanodiamond powders (monocrystalline diamond powder, MSY 0-0.03 micron and MSY 0-0.05 micron) were purchased from Microdiamant, USA. Anhydrous dichloromethane (99.8% #270997), anhydrous pyridine (99.8% #270970), thionyl bromide (97% #251259), ammonia in tetrahydrofuran (0.4 M in THF #718939), ammonia in methanol (4M in methanol #779423), ammonia in isopropanol (2M in isopropanol #392693), anhydrous hydrazine (98% #215155), propargylamine (98% #P50900), N-Boc-propargylamine (97% #687146), N-hydroxysulfosuccinimide sodium salt (sulfo-NHS, 98% #56485) and 1-ethyl-3-(3-dimethylaminopropyl)carbodiimide hydrochloride (EDC, 98% #161462) were purchased from Sigma Aldrich (St. Louis, Mo.). Ammonia gas (99.99/o anhydrous CAS #7664-41-7) was purchased from Praxair (Danbury, Conn.). Anhydrous dichloromethane (99.7%+#41835) and anhydrous dimethyl sulfoxide (99.8% #43998)) were purchased from Alfa Aesar (Haverhill, Mass.). 4-inch silicon wafers coated with a 10 nm titanium adhesion layer and 100 nm layer of gold were purchased from LGA Thin Films, Inc. (Santa Clara, Calif.).

### Procedures.

### Alcohol-Rich HPHT Nanodiamond (ND-OH) Preparation and Storage

A three-zone tube furnace (Thermo Scientific STF55346COMC-1) was utilized to aerobically oxidize 30 nm and 50 nm HPHT nanodiamond (ND). Approximately 500 mg of NDs were aerobically oxidized in a ceramic boat at 525° C. for 5 hours in open air conditions yielding a tannish powder and held at 150° C. prior to removal from the tube furnace. Post oxidation yields were typically 60-65%. The NDs were then placed in a glass scintillation vial and inserted into a drying oven (˜140° C.) to ensure a water free ND surface prior to bromination chemistry. Water free ND-OH samples were stored in the drying oven until needed for further chemistry or spectroscopic characterization.

### Glassware Preparation, Solvent Preparation

All synthetic glassware, including 100 mL and 1000 mL single neck round bottom flasks, Pasteur pipettes, scintillation vials, stir bars and glass adapters were dried in a 140° C. drying oven to remove water 24 hours prior to the start of the bromination. Micropipettes or micropipette tips containing any rubber or plastic pieces were dried at 40° C. in a vacuum oven for 24 hours. Anhydrous solvents were poured over molecular sieves that were activated at 200° C. in vacuo prior to the reactions into a 1000 mL round bottom flasks. The work was performed in a N₂ gas filled Inert Technologies HE-Purelab 4-port glovebox (Amesbury, Mass.).

### ND-Br Synthesis/Purification

Reactions of ND-OH with thionyl bromide (SOBr₂) were setup inside of the N2 glovebox and then transferred to a Schlenk line for 24 hours. Two different bromination reactions, with and without pyridine, were performed in 100 mL single neck round bottom flasks with a Teflon coated stir bar. The non-pyridine reactions were done by charging a round bottom flask with 120 mg of dry ND-OH, 2.5 mL SOBr₂ [1.27 M] and 10.0 mL DCM. The catalyzed reaction was done by charging a round bottom flask with 40 mg of ND-OH, 0.516 mL SOBr₂ [0.6M], 5.467 mL DCM and 0.591 mL of pyridine. Reaction flasks were sealed with a glass adapter, vacuum grease and metal keck clips and removed from the inert atmosphere glovebox and placed in a cup horn sonicator (Fisher Scientific FB505). Cup horn sonication was done at 75% power for five minutes (5 second on/off cycles) and immediately vortexed for one minute to fully disperse the mixture. The samples were then attached to a purged Schlenk line and stirred vigorously at 500 rpm with a N₂ flow rate of approximately 1 mL/second and allowed to react for 24 hours at 25° C. At the 6-hour mark, reactions would be removed from the Schlenk line, cup horn sonicated for 2 minutes and then returned to the Schlenk line for the remainder of the reaction. Three purge and fill cycles were used to remove oxygen and water from the connecting tubing of the Schlenk line to the reaction vessel. After 24 hours, the samples were removed from the Schienk line, sonicated for five minutes using a bath sonicator (Branson 3800), vortexed and introduced into the glovebox.

The pyridine sample contained a black pyridinium perbromide salt that was gelatinous, oily and was a reddish-black tone. The uncatalyzed reaction was bright orange in color. The catalyzed reaction required three purification cycles with DCM, one with DMSO, and a final wash with DCM to conclude the sample workup. The DMSO solubilized the salt during the purification cycle and was complete after one addition. The uncatalyzed reaction only required three purification cycles with DCM. To purify the sample, the sample of ND-Br solution was transferred to a 50 mL polypropylene centrifuge (Beckman Coulter #357003) tube and centrifuged at 21,000 RPM (50,000 rcf) for 30 minutes at 10° C. Note: Centrifugation at 25° C. was found to debrominate the ND-Br and should be avoided. The ND-Br with pellet and supernatant was reintroduced into the glovebox, the supernatant was discarded as waste and the ND-Br pellet collected. To the ND-Br pellet was added 15-20 mL of anhydrous DCM or DMSO, bath sonicated and vortexed. The purification cycles were completed 3 times, during the final wash the supernatant would be optically clear and colorless. ND-Br samples were stored as solid powders or dispersed in 1 mg/mL in DCM for various experiments. Long term storage of ND-Br was in a 4° C. refrigerator as a powder or in solution. ND-Br stability was limited to under 2 weeks and therefore the constructs should be used immediately for further chemistry.

### ND-NH₂ Preparation (Includes Both Ammonia Solution, Condensed Ammonia and Gas Phase)

In the glovebox, a 100 mL single neck round bottom flask was charged with 20 mgs of ND-Br, 1 mL of ammonia in THF [0.4M] and 9 mL of DCM. With propargylamine, a 100 mL round bottom was charged with 20 mgs of ND-Br, 1.4 mL of propargylamine and 3.6 mL of DCM. In both reactions, the flasks were sealed with a glass adapter, attached onto a purged Schlenk line, and allowed to react for 24 hours while stirring vigorously. Bath sonication was used to disperse the ND-Br during the amination chemistry. Reactions can also be performed by sealing with a septum and allowed to react without a connection to the Schlenk line. Purification of ND-NH₂ was done with 10 mL DCM, for a total of three washes at 50,000 rcf for 30 minutes in polypropylene tubes, and a final wash with 10 mL of 18 MΩ water. Condensed NH₃ chemistry was performed by placing 20 mg of ND-Br in a 100 mL round bottom in the glovebox and placing it on the Schlenk line and placing it under vacuum. The round bottom was submerged in an isopropanol and dry ice bath and then back filled with anhydrous ammonia gas and allowed to react as a liquid over neat NH₃ for 30 minutes. The sample was then allowed to warm to 25° C. and the NH₃ returned to the gas phase and yielded a dry aminated ND powder. The ND-NH₂ powder was then purified 3 times with 18 MΩ water and stored at 1 mg/mL solution in water.

Gaseous amination was carried out in a three-zone tube furnace using NH₃ gas at elevated temperatures. In a typical reaction 20-40 mg of ND-Br was loaded into ceramic boats, the boats were inserted into a 50 mL centrifuge tube inside the glovebox, sealed and inserted into the tube furnace under inert conditions. A plastic purging bag with arm slots were connected to the mouth of the tube furnace and purged for 1 hour prior to opening the sealed samples tubes. After 1 hour the tubes were opened the ceramic boats were removed and the samples placed into the quartz tube furnace chamber. The positions of the boats were adjusted to cover the range of 200-700° C. After introduction 3 purge and fill cycles were performed on the tube furnace environment prior to NH3 introduction and elevation of the temperature. The furnace was then filled with ammonia gas (50 sccm flow rate) with a N₂ carrier gas (100 sccm flow rate) and reacted for 2 hours. After the reaction, ammonia was purged for 30 minutes with nitrogen at 1000 sccm and the samples removed. The ND-NH₂ samples were stored in ambient conditions and dispersed in water at 1 mg/mL concentrations.

### Open Air and Inert Atmosphere DRIFTS and TPD-DRIFTS

DRIFTS measurements were performed using the Harrick Praying Mantis DRIFTS attachment (DRK-3), high temperature reaction chamber (Harrick #HVC-DRM-5) and a Thermo Fisher FTIR (6700) equipped with MCT/A detector. The high temperature reaction chamber was cleaned and stored in the vacuum oven prior to being brought back into the glovebox. OMNIC software controlled the Thermo 6700 instrument. Temperature control of the DRIFTS chamber was controlled by Harrick software. DRIFTS measurements were performed with 128 scans at a resolution of 2 cm⁻¹ and background scans of near or equal signal intensity. KBr powder was stored in an oven (120° C.) 24 hours prior being brought into the glovebox. When bringing the KBr or DRIFTS chamber into the glovebox, three 3-minute purge and fill cycles were performed to remove any oxygen and water. All DRIFTS work was performed inside the glovebox under inert conditions. For collecting background data, 80 mgs of the dried KBR was used and filled the DRIFTS cup completely. Using a mortar and pestle, the KBr was ground into a fine powder, introduced into the cup and the excess KBr was then leveled with a sample preparation tool leaving a flat and gouge-free KBr surface. The IR reflectance spectrum scans were set at 128 scans and the background data were collected. The saved background data was then applied for subsequent data collection. This process was repeated for temperature dependent studies and the background files were saved. For collecting sample data 3-4 mgs of ND-OH, ND-Br or ND-NH₂ were added to 80-90 mg of KBr and mixed thoroughly. Sample DRIFTS data was collected in percent reflectance mode with a representative background scan.

### DRIFTS Parameters and Analysis.

Kubelka-Munk transformations were performed individually with linear background corrections in Igor Pro software. Linear backgrounds were generated based on the averaged values of percent reflectance (raw data) in the DRIFTS regions of 2000-2200 cm⁻¹ and 3800-4000 cm⁻¹. This slope value was then applied to a y-intercept function (y=mx+b) and applied to spectra for normalized reflectance units (R) and then transformed using the Kubleka-Munk equation to make the data proportional to concentration:

$$K M Units = \frac{( 1 - {R}^{2} )}{2 R} \qquad ( 1 )$$

Infrared values were cross referenced to Infrared and Raman characteristic group frequencies: tables and charts by Socrates and HPHT ND studies.⁷⁻¹¹

### ND-OH, ND-Br and ND-NH₂ Deposition on Gold Coated Silicon Wafers for XAS, XPS and XES Experimentation.

Gold-coated silicon wafers from LGA thin films (Santa Clara, Calif.) were cut into 1×1 cm squares, bath sonicated in acetone, isopropanol, 18 MΩ water three times, and dried with a N₂ gun. The wafers were then etched for a minimum of 10 minutes with a piranha solution (90 mL concentrated sulfuric acid and 10 mL hydrogen peroxide), with the gold layer facing upwards in a crystalizing dish. After drying the etched Au wafer, 300 μl of 1 mg/mL ND solution was deposited and dried onto the substrate and covered with a crystallizing dish. Moisture-sensitive brominated nanodiamond samples were prepared in an inert atmosphere glove box using dichloromethane as the solvent in a similar fashion. Piranha etched wafers were dried for 24 hours at 140° C. prior to be introduced into the glovebox and ND-Br being deposited to insure a water free surface. Oxidized and aminated nanodiamond samples were prepared using 18 MΩ water as a solvent under open-air conditions at 1 mg/mL concentrations. Note: A 10 nm Ti or Cr adhesion layer is used prior to 100 nm gold deposition on Si substrates. Piranha etching did cause pin hole etching of the gold and adhesion layers and Si XPS signals were observed.

### Synchrotron XAS Data Collection, PFY-XAS/XES Analysis and RIXS Measurements

X-ray absorption (XAS) and resonant inelastic X-ray scattering (RIXS) measurements were performed at beamline 8-2 and 10-1 at the Stanford Synchrotron Radiation Lightsource, SLAC National Accelerator Laboratory using a spot size of <1 mm². All samples were handled in an inert atmosphere glovebox and mounted to an Al sample bar with conductive carbon tape (#16073-4 Ted Pella, Inc. Redding, Calif.). The samples were transported to the beamline in a sealed polypropylene jar and a magnetic mounting piece was attached to the sample bar in inert atmosphere glovebox. The sample bar was then brought to the beamline and purged with N₂ gas for 60 minutes inside a plastic glove hands attached to the transfer chamber. Once purged, the transfer chamber was vented and the sample bar was introduced into the transfer chamber under a positive pressure N₂ flow. Samples were introduced into the analysis chamber after the transfer chamber reached 1*10⁻⁷ torr. Analysis chamber conditions were typically conducted at 5*10⁻⁹ torr.

At 8-2 and 10-1, carbon, nitrogen and oxygen K-edge XAS was measured in total electron yield (TEY) mode using 42×42 μm, 40×40 μm, and 30×30 μm slits, respectively. TEY mode probes approximately 5-10 nm of the sample depth and all experiments were conducted under ultrahigh vacuum conditions (˜5*10⁹ torr). After focusing the optics, the reference absorption intensity of the incoming X-ray beam was measured using a sample of gold coated mesh and used to correct for beam instability. XAS data was collected at an incident electric field vector of 54.7°. For spectral analysis the data was treated with a linear pre-edge background subtraction from a region before the absorption edge of carbon, nitrogen and oxygen at 260-280 eV, 370-380 eV and 510-530 eV, respectively. A post-edge normalization was also performed in the continuum region at 340 eV for carbon, 420 eV for nitrogen and 580 eV for oxygen and performed using a batch processing macro in Igor Pro. Energy calibration was performed using the signal from the diamond core-hole exciton which is determined to be 289.0 eV as described elsewhere. X-ray energy calibration of the synchrotron light source was performed during grating changes with a Ni slab (Ni L3 absorption) and a 1-point fitting procedure.

RIXS measurements were performed using the super conducting transition edge sensor (TES) X-ray detector as described elsewhere by Lee and Titus. The TES allows for background-free X-ray detection without a diffraction grating and good energy resolution (1 eV). A resonant inelastic X-ray scattering (RIXS) measurement is performed by sweeping across the excitation monochromator photon energies and collecting a time-tagged X-ray pattern across the TES detector. The TES allows for all photons to be simultaneously collected across all detector elements in the array. Analysis of the RIXS data produced by the TES detector is covered thoroughly by Lee et al.

### Laboratory XPS Measurements and Analysis

A Thermo Scientific K-Alpha Surface Analysis XPS instrument at the Molecular Foundry was utilized to probe for carbon, nitrogen, and bromine signals on the surface of the ND-Br and ND-NH₂ samples. The K-Alpha Plus XPS has a combined low energy electron and ion flood source and are utilized to suppress charging during all data collection. The XPS X-ray source and detector is an Al Kα micro-focused monochromator and is equipped with a 180° double hemispherical analyzer with a 128-channel detector. The low resolution and high-resolution pass energy are 200.0 eV and 50.0 eV, respectfully. The low resolution and high-resolution energy step size are 1.0 eV and 0.1 eV, respectively. For high-resolution scans, 50 scans were taken of bromine and nitrogen and 10 scans for oxygen and carbon to ensure good signal to noise and a dwell time of 50 ms. The electron acceptance angle was 55° and survey scans were performed over a binding energy range from 0-1350 eV, a pass energy of 200 eV, 3 scans were summed and a dwell time of 10 ms was used. ND-Br samples that required air-free transfer from the glove box to the K-alpha XPS instrument were loaded into the inert atmosphere transfer module. ND-Br samples were loaded into the transfer module for analysis and transported from SJSU to The Molecular Foundry.

XPS analysis was performed using Igor Pro software and the CASA-XPS software package and standard background subtraction and fitting protocols were followed on survey and high-resolution scans. For example, a linear background subtraction was performed on N1s high resolution scans in Igor Pro and then peaks were fit to a Voigt line shape with a mixed Gaussian and Lorentzian contribution. Peak widths were typically held to a FWHM of 1.5-2.0 eV as appropriate for the spectral features. Quantitative analysis of survey scans to determine the atomic percentage of individual elements was performed using CASAXPS software and Tougaard backgrounds were applied with relative sensitive factors (RSF) values being applied for each element. RSF values for C, N, O and Br were 1.0, 1.8, 2.93 and 2.8, respectively. Percentage atomic concentrations (X_{A}) are calculated using equation:

$${X}_{A} = \frac{( {I}_{A} {E}^{α} ) / ( {R}_{A} T ( E ) )}{\sum ( {I}_{i} {E}^{α} ) / ( {R}_{i} T ( E ) )} \qquad ( 2 )$$

Wherein, X is the atomic percentage of element A, Rᵢ is the RSF for the relative intensity Iᵢ and T(E) is the transmission function of the instrument for intensity Iᵢ at kinetic energy (E). The alpha term in the exponent of kinetic energy E is used to adjust for analyzer specifications. The VAMAS (Versailles Project on Advanced Materials and Standards) file collected by the K-Alpha instrument allowed for all needed transmission function information to be applied for quantification purposes and the VAMAS file type is ISO 14976 compliant. XPS features from the thin film substrate include Au4f, Si2p and Ti3s found at 85 eV, 99 eV and 59 eV, respectively.
Time Dependent Study of Bromination Chemistry with and without Pyridine

Addition of pyridine accelerated the SOBr₂ bromination of ND-OH constructs and also produced a viscous side product of pyridinium tribromide (PTB) (NC₅H₅·HBr·Br₂). The PTB

TABLE 1
Inelastic mean free paths of C1s, N1s, O1s and
Br3d electrons and sensitivity factors based on transmission
functions in VAMAS files.^{4, 6}

| | | | Sensitivity |
|---|---|---|---|
| Element | Edge | IMPF (nm) | factors |
| Carbon | 1s | 1.87 | 1.0 |
| Nitrogen | 1s | 1.78 | 1.8 |
| Oxygen | 1s | 1.67 | 2.93 |
| Bromine | 3d | 2.03 | 2.8 |

side product was removed with a single DMSO washing step and the salt could be observed in a portion of the decanted supernatant. Post purification samples produced a light tan to light greyish tone for the pelleted samples and the supernatant would be optically clear and colorless after 3 purification cycles.

The increased rate of ND-Br formation with pyridine can be observed when comparing 2-hour and 24-hour reactions and tracking the emergence of the (C—Br)_{ν} stretching mode at 750 cm⁻¹. The (C═O)_{ν} of carboxylic acids at 1780 cm⁻¹ shifts to 1815 cm⁻¹ during the bromination process and is assigned to an acid bromide. Peaks arise in the 950-1050 cm⁻¹ region as early as 2 hours and are not static between any of the reaction conditions. Assignment of the 950-1050 cm⁻¹ region has not been completed and is most likely due to oxygen and bromine containing intermediates on the diamond surface. The peak at 1025 cm⁻¹ is assigned to the (C—O—C)_{ν} bridging vibrational mode of an ether moiety caused by the intracrystallite Williamson ether-like surface reaction. The sample surface is free of physiosorbed water as evidenced by the lack of a (O—H)_{δ} mode at 1630 cm⁻¹.

### Debromination and Analysis of ND-Br in Open Air Conditions.

The instability of the C—Br bond on the HPHT nanodiamond surface is clearly illustrated by DRIFTS measurements at 25° C. A ND-Br sample was observed to have a strong (C—Br)_{ν} peak at 750 cm⁻¹ in inert conditions using the Harrick inert atmosphere chamber. To initiate the debromination, two VCO caps were removed from the Harrick chamber and the DRIFTS spectra was collected at various time points until the C—Br vibrational mode was extinguished. As early as the first scan collected within 5 seconds of the VCO cap opening there was a detectable decrease in (C—Br)_{ν} peak intensity and is labeled a 2-minute scan (FIGS. 1 and 2). Data collection of 128 scans at 2 cm⁻¹ resolution takes approximately 2 minutes. This instantaneous degradation of the C—Br bond is highly unusual and is not consistent wither other bromide derivatives such as 1-bromoadamantane, which can be handled in open air conditions without degradation. In contrast, hydrolysis studies of 1-bromoadamantane with NaOH in a water-toluene-polymer tri-phasic system required 0.1 M NaOH at 100° C. in the presence of a catalyst to generate 1-hydroxyadamantane.

Kinetic analysis of the debromination process concluded that the loss of C—Br bonds at 25° C. in open air conditions was best modeled as a pseudo first order reaction in a reaction scheme similar to:

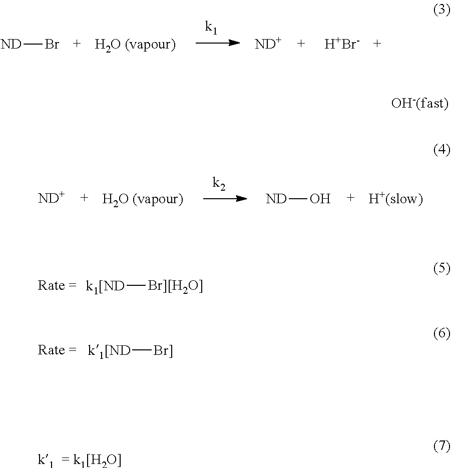

The observations based on DRIFTS suggest that a long lived carbocation or other reactive intermediate on the nanodiamond surface may exist for 80 minutes or longer at 25° C. Prediction of a “radical carbon” based on brominated diamond was found through DFT by Larsson and Lunell and was not observed with chlorine or fluorine termination.²² An analogous system would be that of 8,9-dehydro-2-adamantyl with a stable carbocation at −120° C. and confirmed via ¹H and ¹³C NMR. NMR is not sensitive enough to be used for surface analysis of HPHT ND samples and therefore such experiments are not appropriate. In-situ gas phase amination will be required to reinforce the time dependent formation of amines on the diamond surface. The lability of the C—Br bond, the unique properties of diamond and the low concentration of water molecules in atmospheric conditions have aided this observation. Exposure to water in the gas or liquid phase leads to the loss of carbon-bromine bonds and anhydrous conditions should be followed.

No observed rehydroxylation of the sample occurred during the 80-minute experiment because we do not observe an increase or return of the (C—O)_{ν} mode at 1105 cm⁻¹ representative of alcohol-rich NDs, and no shifting or movement of line shapes occur during the air-exposure. Our conclusion is that rehydroxylation is slow compared to the debromination kinetics with 60% relative humidity at 25° C. [767 μM]. Pseudo 1^{st} order reaction analysis yields a rate constant k′=7.23*10⁻⁷ l/s (k′=0.001 M⁻¹ s⁻¹*[767 μM] as seen from FIGS. 3-6. As a control, ND-Br was reacted with 2 mL of 18 MΩ water [55.5 M], purified by centrifugation and probed with DRIFTS and shows the reemergence of an alcohol-rich surface within 1 minute of reaction time. Based on the molarity of pure water, the pseudo 1^{st} order rate of k′=0.055 l/s (k′=0.001 M⁻¹ s⁻¹*[55.5M], an increase of 7.2*10⁴ in the pseudo first order experimental rate. Based on a reaction in water, the rehydroxylation reaction in neat water would be complete in 66 ms.

### Debromination and Analysis of ND-Br During Thermal Desorption Under Inert Conditions.

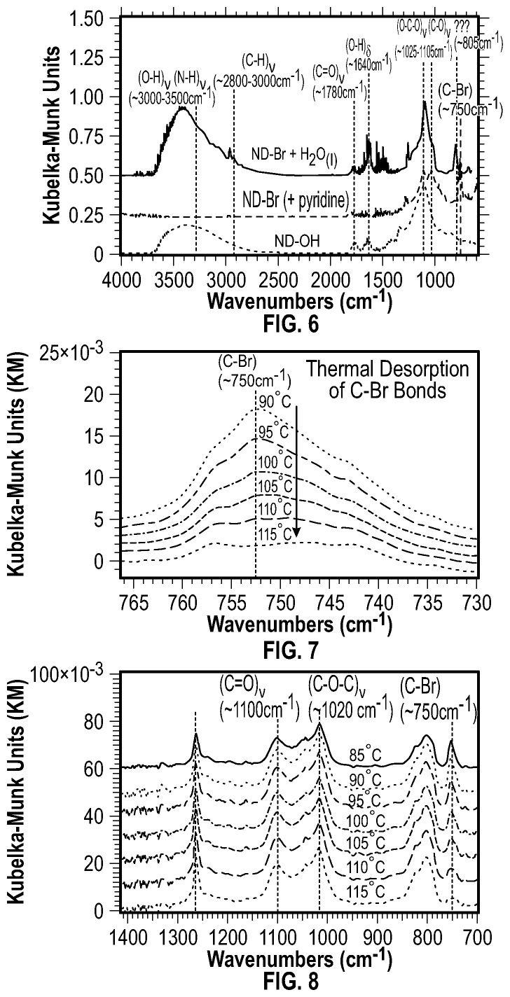

Instantaneous covalent bond dissociation of the carbon-bromine bond on the nanodiamond surface was observed at 90° C., consistent with a highly labile leaving group on the diamond surface. Temperature programmed desorption-DRIFTS or TPD-DRIFTS allows the stability of the C—Br bond to be examined in inert conditions. Samples are loaded into the Harrick high temperature reaction chamber in the inert atmosphere glovebox and the TPD-DRIFTS measurements occurred from 70-120° C. To insure proper TPD-DRIFTS, KBr backgrounds at experimental temperatures were taken and applied for each spectrum collected. Data for 85-115° C. are displayed in FIGS. 7 and 8. Noticeable reduction in the (C—Br)_{ν} peak was observed at 90° C. within 2 minutes of the temperature being reached.

Importantly, it was found that over a 2 week period, the ND-Br samples would debrominate in the glovebox at 25° C. (data not shown) and highlights that the C—Br bond dissociation mechanism is active at 25° C., but is slow compared to our experimental temperature of 90° C. Our findings are consistent with a weakening of the carbon-halide bond on the diamond surface as the halide identity changes from fluorine, chlorine and bromine atoms. Previous studies showed that thermal bond dissociation of carbon-fluoride and carbon-chloride bonds on single crystal diamond were observed to occur from 227-920° C. and 150° C., respectively. A further temperature reduction below 150° C. is reasonable and observing spontaneous C—Br dissociation at 90° C. within the TPD-DRIFTS measurement time of 2 minutes indicates the reaction is kinetically fast. Bond dissociation energies have not been derived in this study but are expected to be less than 2.21 eV/bond or 214 kJ/mol as calculated for 1-bromoanaline using G4 thermochemical calculation.

### Nanodiamond Surface Analysis Based on XPS Survey Scans.

Quantitative elemental analysis of the ND surface was performed with the survey scans of the respective samples. The quantification required 2 steps; 1) quantitative analysis based on the CASAXPS software package assuming a uniform distribution of the elements with resulting atomic percentage concentrations and 2) applying a simple model that represents the surface coverage of heteroatoms nitrogen, oxygen and bromine on the nanodiamond substrate and the attenuation of the C1s signals. Recall that relative sensitive factors (RSF) values being applied for each element are seen in equation 2. RSF values for C, N, O and Br are 1.0, 1.8, 2.93 and 2.8, respectively, and shown in table 1. RSF values used in the CASAXPS analysis package are a function of Scofield cross sections at the Al Kα X-ray emission wavelength and are used to calculate the percentage atomic concentrations.

The inelastic mean free paths (IMFP) of C1s, N1, O1s and Br3d photoemitted electrons from the sample are calculated to be ˜1.7-2.0 nm with the Al Kα (hν=1486.6 eV) source used in this study. These IMFP values are calculated from Seah and Dench based on binding energies of 284 eV, 399 eV, 532 eV and 70 eV for C1, N1s, O1s and Br3d, respectively and the universal IMFP equation,

$$λ = \frac{143}{{E}^{2}} + 0.054 * \sqrt{E} \qquad ( 8 )$$

wherein, λ and E are the inelastic mean free path and energy of the electron in electron volts (eV). Additional versions of the IMFP equation have been presented by Seah, but will not be covered here. Because N1s, O1s and Br3d species will only be present as an atomic layer at the diamond surface, the IMFP is not relevant for those elements (λ_{C1s}=λ_{N1s}). Therefore, the C1s photoemitted electrons are the only XPS signal limited by the IMFP and table 2 summarizes our results of several samples for alcohol, bromine and amine terminated NDs.

The C1s XPS intensity and attenuation is based on a IMFP of 1.87 nm and is given by

I(d)=Iₒe^{-d/λ} (8)

wherein I(d) is the signal intensity as a function of d in nm, Iₒ is the initial intensity in a pure substance and λ is the IMFP. Solving for distance (d) based on the observed intensity yields,

$$- d = ln ( \frac{I ( d )}{{I}_{0}} ) * λ \qquad ( 9 )$$

In a similar expression given by Kono et al. they express the C1s XPS intensity by,

$${I}_{1 C s} = C * {C}_{C} * {σ}_{C 1 s} * {T}_{C1s} * {\int }_{0}^{∞} {e}^{- \frac{z}{{λ}_{C 1 s} ⋆ cos θ} d z} \qquad ( 10 )$$

where C is an instrument constant based on photon flux and geometry, C_{c} is the concentration of carbon atoms in diamond, σ_{C1s} is the photoionization cross section, T_{C1s} is the transmission function for the electron analyzer, λ_{C1s} is the mean free path and z is the depth from the top of the diamond surface. σ_{C1s}*T_{C1s} is commonly known as the relative sensitivity factor (RSF) and given as 1.0 for carbon and can be seen in table 1. All elements in the CASAXPS software use a specific RSF based on the instrument configuration, photoionization cross sections and transmission function. Measurement of a thin homogenous layer that dampens the C1s signal is then described by

$$d = {λ}_{imp} ⋆ cos θ ⋆ ( \frac{{I}_{imp}}{{I}_{C 1 s}} ) ⋆ ( \frac{{σ}_{C 1 s}}{{σ}_{imp}} ) ⋆ ( \frac{{T}_{C 1 s}}{{T}_{imp}} ) ⋆ ( \frac{{λ}_{C 1 s}}{{λ}_{imp}} ) \qquad ( 11 )$$

wherein the λᵢₘₚ is assumed to be the same as λ_{C1s} and θ=55° across all measurements.

Because all other XPS signals are from a monolayer (ML) or less, their respective IMPFs for N1s, O1s and Br3d are not needed as they are not attenuated as a function of distance. Kono et al. states that the overlayer has the same IMFP as C1s electrons as seen in equation 11 and λ_{C1s}=λ_{N1s}(λ_{C1s}=λ_{O1s}, λ_{C1s}=λ_{Br3d}), is assumed in this study as well.

### Analysis of C1s Signal Attenuation as a Function of Distance and Overlayer Thickness (d).

Using equation 9, the natural log of attenuated experimental intensity over the initial intensity (value=1000) and λ_{C1s} was used to calculate d in nanometers as seen in the crosses of FIG. 8 and plotted. The signal decay scales as e^{-(d/λ)} and a theoretical C1s plot based on equation 8 with the attenuated intensity as a function of d is used as a guide for the eye. The value of d in nanometers is the estimated overlayer thickness of oxygen species (hydroxyls), bromines (alkyl-bromides) and nitrogen (amines) species and is given as 0.27 nm, 0.43 nm and 0.68 nm, respectively as seen in FIG. 8. The bond distances of hydroxyl, alkyl bromides and amine moieties on diamond surfaces have been calculated via DFT previously. The calculated C—O bond distance of hydroxyls on 111 to be 0.141 nm, 0-H bonds to be 0.0995 nm and a C—O—H bond angle of 109.7°. Tiwari calculated a C—Br bond distance of 0.191 nm at 50% bromine coverage and a C—C—Br bond angle of 107.3°. Miyamoto and Saito model the diamond surface with surface nitrogen and find the C—N bond distance to be elongated to 0.189 nm (second layer) and 0.232 nm (top layer) when hydrogen atoms are present and bound to nitrogen. Miller found amine terminated diamond to have N—H bond distances of 0.0985 nm when hydrogen bonding is considering and a H—N—H bond angle of 106.3°, but did not state C—N bond distances or C—N—H bond angles. The elongation of the C—N bond distance at the diamond surface is consistent with the observed decrease in C1s signal in ND-NH₃ samples and calculated overlayer distance (d) of 0.68 nm as found in FIG. 8 and table 2 values. Water adsorption of 1 ML is the cause of the increase in O1s % signals after amination chemistry, and is also supported by increased water adsorption in DRIFTS measurements seen in FIG. 2B in the main article. ND-NH₃ samples were deposited from an aqueous solution onto the Au coated wafers and allowed to dry gradually. DFT has been used to model adsorbed water on hydroxyl terminated diamond and found a relaxed structure of 0.250 nm between adsorbed water and surface hydroxyl groups. In total, based on DFT calculations, a 0.523 nm overlayer thickness in the ND-NH₃ samples is predicted which is close to the calculated d value of 0.431 nm using equation 10 based on our experimental XPS data (see FIG. 8). Equations 8 (solid trace) and 10 (dashed trace) in FIG. 8 overestimate the thickness of the overlayer based on C1s intensity for all samples investigated when compared to theoretical bond distances. Equation 11 from Kono provides the best thickness values based on experimental XPS data in comparison to DFT. Equation 11 both underestimates (ND-OH and ND-NH₃) and overestimates (ND-Br) the overlayer thickness values with deviations of −0.010 nm, +0.186 nm and −0.092 nm for ND-OH, ND-Br and ND-NH₃, respectively.

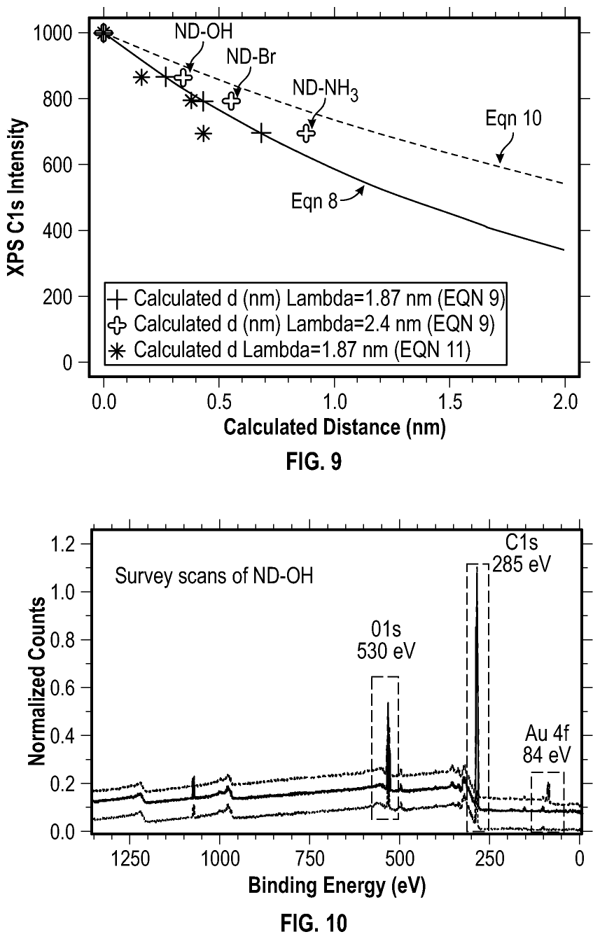

The disclosed model for determining the percentage of surface sites that were functionalized with alcohols, bromides or amines is based on assuming that all carbon signals originate from the diamond nanoparticle, atomic percent concentrations are taken from XPS survey scans, that C1s signals are attenuated as a function of overlayer thickness and that alcohol rich ND surfaces provides a upper limit of 15% O1s atomic percent concentration when no adsorbed water is present. Because the ND-OH samples were dried prior to XPS measurements and mounted in the glovebox, we estimate that no adsorbed water is present for the control sample. The initial model for HPHT ND-OH surfaces assumes near complete coverage of alcohols on the surface and would be equivalent to a 15% atomic percent concentration on single crystal diamond. A 12% and 16% oxygen content is described on the 111 and 100 diamond facets through XPS characterization, respectively. No ND-OH control sample data exceeded 14.2% of oxygen species based on survey scan analysis (see table 2 and FIGS. 9-11). The 15% upper limit of oxygen surface species on HPHT ND-OH is reasonable considering increased surface roughness and increased surface to volume ratio of the 30-50 nm NDs. Additionally, 1 monolayer (ML) of alcohols is equivalent to approximately 18.2 alcohols per nm² on the 111 surface and is used throughout our calculations in Table 3.

Elemental quantification from XPS survey scans is provided in Table 2 and is based on the relative sensitivity factors and backgrounds previously described. To convert between the distributed atomic percentages provided by CASAXPS and yield a meaningful surface termination we use the following procedure. Atomic % for oxygen of ND-OH is 15% at a full alcohol termination and the calculated oxygen % in table 2 is divided by the maximum of 15% and the ratio estimates the alcohol termination present at the diamond surface. For example, ND-OH-1 in table 2 has a 13.4% oxygen content and therefore represents an alcohol coverage of 89.3% and is then multiplied by 18.2 surface groups/nm² on the 111 facet to provide the figure of 16.3 alcohols/nm² in parentheses. ND-OH-2 with a 14.2% oxygen content is then calculated to have a 95% alcohol coverage with 17.3 alcohols/nm². ND-Br sample calculations follow the same method, but are complicated by spontaneous C—Br bond cleavage in ultrahigh vacuum conditions that decreases the initial bromine concentrations. Based on this method, ND-Br-1 with 0.5% Br content is determined to have a 3.3% Br coverage or 0.6 alkyl-bromides/nm². The alcohol coverage is the remaining surface coverage of 96.7% or 17.6 alcohols/nm² in table 3. The actual Br coverage prior to debromination is higher and explained in conjunction with the amine results at the end of the section. Notice that the oxygen % for ND-Br-1 is 20.1% in table 2 and is over the established 15% of ND-OH control samples and is caused by the attenuation of the C1s signal by the larger thickness (d) of the brominated surface C—Br bonds. The oxygen surface content (caused by either alcohol or ether moieties via Williamson ether rearrangement) is therefore an overestimate and an accurate value is not known.

ND-NH₃ sample calculations are more accurate because the sole source of nitrogen atoms comes from C—N bond formation at the diamond surface and photoemitted N1s electrons are not attenuated. In an example calculation, ND-NH₃-1 has a 7.8% nitrogen content from table 2 and represents an amine surface coverage of 52% or 9.5 amines/nm² and a balance of 48% alcohols or 8.7 alcohols/nm². This value is calculated by dividing the nitrogen % by the maximum oxygen % of 15% from the dry ND-OH samples. The exchange of N atoms for O atoms must be a 1:1 ratio due to the alcohol to amine surface transformation during the S_{N}1 or E1 mechanism following the debromination process. Additional % oxygen content is from ˜1 ML of physically adsorbed water that increases the oxygen % to 22.8%. The attenuation of the C1s signal is due to the increased bond lengths of the amines and the thickness increase of the water adsorption layer as previously described. Critically, the amine content is a truer estimation of the original bromination rates and we can therefore claim that rates of 36-52% have been achieved and therefore approach the theoretical limits calculated by DFT. Addition of the amines along the ND surface are only possible if preceded by the bromine leaving group, a reactive intermediate being produced and the nucleophilic attack of the surface carbon atom by the approaching NH₃ molecule as illustrated in FIGS. 9-11. Surface termination of ND constructs after amination chemistry have therefore been quantified to be ˜36-52% or 6.5-9.5 atoms of the surface carbon sites. This estimation is based on a predominant {111} crystallographic expression with 18.2 atoms/nm² due to the ball milling process of HPHT diamond as previously discussed.

The discrepancy between atomic % of Br3d and N1s and the champion samples have 2.5% and 7.8% for Br3d and N1s, respectively. This observation was rationalized as due to alkyl-bromides spontaneous degradation as a function of time (post synthesis) and the ultra-high vacuum (UHV) conditions used for XPS, thereby decreasing the percentage contribution during analysis. Adsorption of bromides on Si(100) and Ge(100) have been studied with core-level electron spectroscopy and STM and along with DFT calculations of Br on diamond 111 shows large steric hindrance and low adsorption energies for Br. Notably, surface bromides on diamond are known via DFT to be highly unstable and never examined physically until now. Increases in O1s signal and decreases in C1s signals during the ND-Br and ND-NH₃ transformations are due to the bulkier surface adsorbates (Br radius of ˜180 pm versus —OH of ˜100 pm) suppressing

TABLE 2
Quantitative summary of XPS Survey Scans based on CASAXPS
analysis. (10% error assumed for all values).

| | Surface | Carbon | Nitrogen | Oxygen | Bromine |
|---|---|---|---|---|---|
| Sample | Termination | % | % | % | % |
| ND-OH-1 | Alcohols | 86.6 | 0.0 | 13.4 | 0.0 |
| ND-OH-2 | Alcohols | 85.8 | 0.0 | 14.2 | 0.0 |
| ND-OH-3 | Alcohols | 87.0 | 0.0 | 13.0 | 0.0 |
| ND-Br-1 | Alkyl-bromides | 79.4 | 0.0 | 20.1 | 0.5 |
| ND-Br-2 | Alkyl-bromides | 78.6 | 0.0 | 20.3 | 1.1 |
| ND-Br-3 | Alkyl-bromides | 73.8 | 0.0 | 23.7 | 2.5 |
| ND-NH₃-1 | Amines | 69.4 | 7.8 | 22.8 | 0.0 |
| ND-NH₃-2 | Amines | 65.5 | 6.3 | 28.2 | 0.0 |
| ND-NH₃-3 | Amines | 69.0 | 5.4 | 25.6 | 0.0 |

TABLE 3
Summary of Surface Groups (—OH, —Br, NH₃ and adsorbed
water) based on surface functionalization model. The number in parentheses
is the number of surface groups per nm² (atoms/nm²).

| | Surface | Alcohol | Bromide | Amines | |
|---|---|---|---|---|---|
| Sample | Termination | % | % | % | ML Water |
| ND-OH-1 | Alcohols | 89 (16.3) | 0.0 | 0.0 | 0.0 |
| ND-OH-2 | Alcohols | 95 (17.3) | 0.0 | 0.0 | 0.0 |
| ND-OH-3 | Alcohols | 87 (15.7) | 0.0 | 0.0 | 0.0 |
| ND-Br-1 | Alkyl-bromides | 96.7 (17.1) | 3.3 (0.6) | 0.0 | 0.0 |
| ND-Br-2 | Alkyl-bromides | 92.7 (16.1) | 7.3 (1.3) | 0.0 | 0.0 |
| ND-Br-3 | Alkyl-bromides | 83.4 (15.2) | 16.6 (3) | 0.0 | 0.0 |
| ND-NH₃-1 | Amines | 48.0 (8.7) | 0.0 | 52.0 (9.5) | 1.0 |
| ND-NH₃-2 | Amines | 58.0 (10.5) | 0.0 | 42.0 (7.6) | 1.0 |
| ND-NH₃-3 | Amines | 64.0 (11.6) | 0.0 | 36.0 (6.5) | 1.0 |

subsurface diamond photoelectrons. Additionally, after amination chemistry, increases in oxygen content arise from increased adsorbed water on the ND-NH₃ surface (see FIG. 1B DRIFTS measurement) and would generate a tightly bound water monolayer on the diamond surface that would not desorb at 25° C. under UHV conditions.

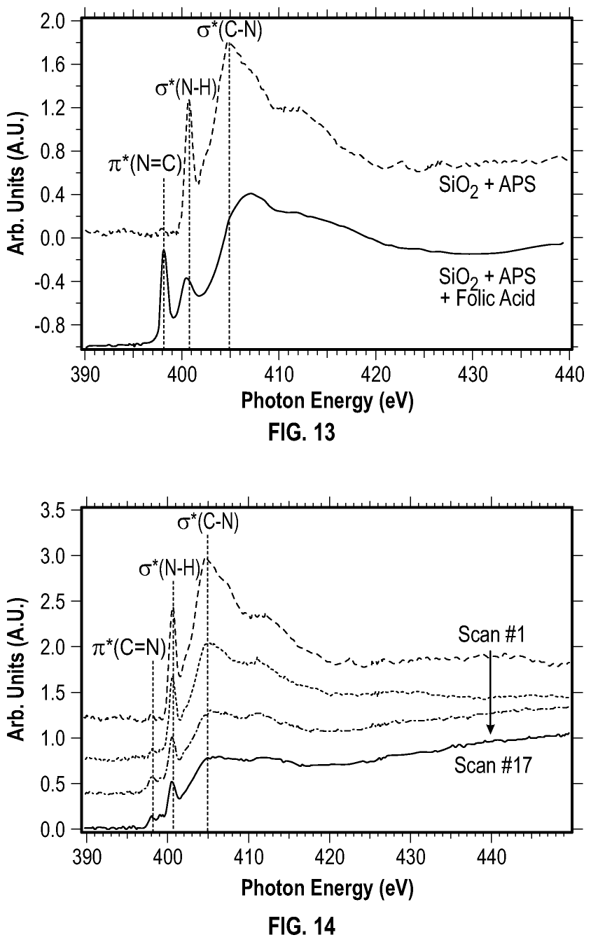

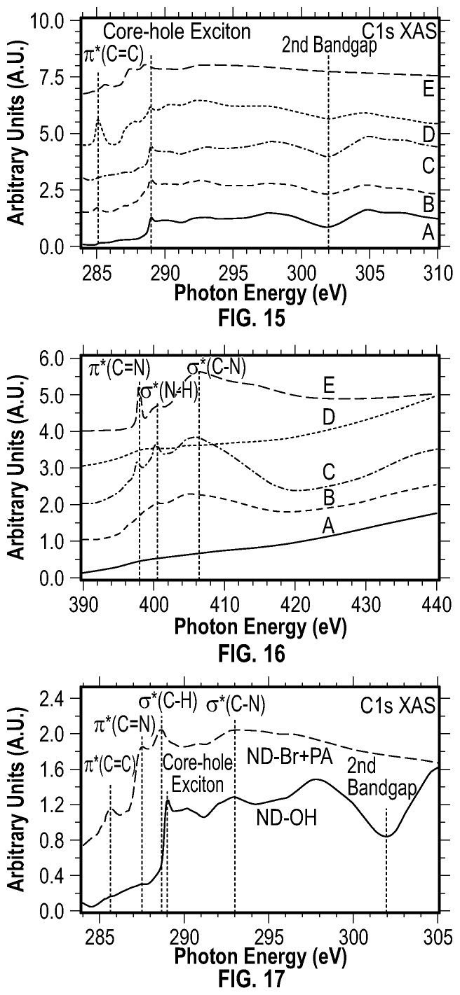

Conformation of N1s XAS spectra peak positions for π*(C═N), σ*(N—H) and σ*(N—H) was supported by amine functionalization of silica-coated NDs (FIGS. 12 and 13). ND-SiO₂ samples were prepared similar to the route of Cigler et al. and functionalized with 3-amino-propyltrimethoxysilane or APS. Peaks of amine functionalized silica NDs at ˜400.6 eV and ˜405.0 eV are assigned to σ*(N—H) and σ*(N—C) resonances, respectively (FIG. 9). The environment of the N atoms in APS is similar to a single molecule and is bound to the ND-SiO₂ surface through siloxane bonds and is a good model system. The same sample was used for a control conjugation step with amine terminated ND-SiO₂ and folic acid using sulfo-NHS/EDC coupling reagents. A new π*(C═N) resonance arise due to the planar amide bond that was formed and is in agreement with the results of ND-NH₂ conjugated to folic acid with sulfo-NHS/EDC coupling (PFY-XAS data in FIGS. 4B and 5C).

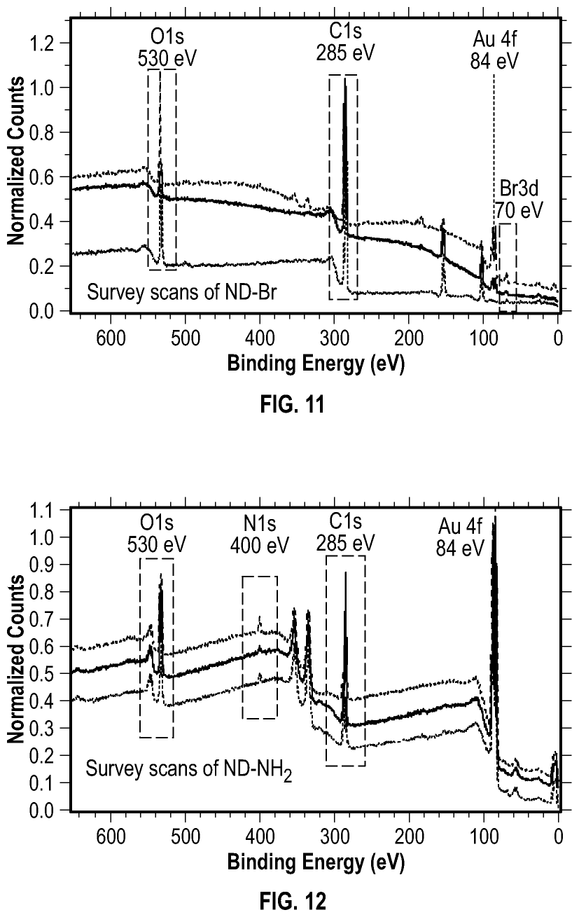

The Example shows that radiation damage of the control ND-SiO₂ samples with amine functionalization and can justify why π*(C═N) resonances may arise in ND-NH₂ samples after X-ray irradiation. In FIG. 11 the emergence of π*(C═N) resonances at 398.2 eV appears after scan #5 and maximizes at scan #17. There is no π*(C═N) resonance at scan #1 and is consistent with a purely C—N and N—H bonding environment around the nitrogen atoms. The impinging X-ray is deprotonating the amine groups (—NH₃) generating an imine bond and the resultant rise of the π*(C═N) bond resonance. X-ray beam damage is common and has been highlighted elsewhere.

N1s and C1s XAS spectra provides surface termination and electronic structure information of the ND constructs and provides evidence of a polymerization reaction with ND-Br and propargylamine (PA). The rationalization for choosing PA as a nucleophile is that PA would render C—N bonds at the diamond surface (assuming nucleophilic attack by the nitrogen center on the carbocation) and retention of the alkyne that would be later used in click-chemistry reactions with azides. ND-OH is our control sample and shows clear signatures of diamond with the diamond core-hole exciton and 2^{nd} bandgap at 289.0 eV and 302.0 eV, respectively. ND constructs that were aerobically oxidized ND-OH (A) and all chemically treated samples with NH₃₍ₗ₎·THF and NH_{3(g)} at 300° C. (samples B→D) show clear signatures of diamond's electronic structure, but is not observed in the PA reacted samples (sample E in FIGS. 14 and 15). The PA treated sample was thoroughly purified using DCM and water via centrifugation and decanting cycles. The C1s and N1s spectra of PA treated NDs is therefore representative of the polymerized PA with π*(C═N), π*(C═C), σ*(C—N), σ*(C—H) and σ*(N—H) resonances and not the nanodiamond core electronic structure. Control reactions of ND-Br with N-Boc propargylamine did not show strong nitrogen signals, did not suppress the diamond electronic structure and suggests that the polymerization pathway was sterically halted by the N-Boc protecting group on the nitrogen center (data not shown).

Suppression of a substrate electronic structure information has been previously reported for SiO₂ on Si substrates and SiO2 on highly ordered pyrolytic graphite using total electron yield (TEY) and fluorescence yield (FY) measurements. TEY measurements found a probe depth of 5 nm for the L-edge and 70 nm for the K-edge of Si. Our XAS measurements in TEY mode for C1s probe 5-10 nm into a sample and complete suppression of the diamond electronic structure suggests we have a minimum of 5 nm of a PA-based shell on our ND core. The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Aspect 1 provides a functionalized nanoscale diamond comprising:

a functionalized surface comprising:
a brominated portion; and
a hydroxylated portion.

Aspect 2 provides the functionalized nanoscale diamond of Aspect 1, wherein the brominated portion comprises a plurality of bromine atoms bonded to carbon atoms at the surface of the functionalized nanoscale diamond.

Aspect 3 provides the functionalized nanoscale diamond of any one of Aspects 1 or 2, wherein the hydroxylated portion comprises a plurality of hydroxy groups bonded to carbon atoms at the surface of the functionalized nanoscale diamond.

Aspect 4 provides the functionalized nanoscale diamond of any one of Aspects 1-3, wherein the brominated portion comprises 10 to 50 percent of a total surface area of the functionalized surface.

Aspect 5 provides the functionalized nanoscale diamond of any one of Aspects 1-4, wherein the brominated portion comprises 20 to 40 percent of a total surface area of the functionalized surface.

Aspect 6 provides the functionalized nanoscale diamond of any one of Aspects 1-5, wherein the hydroxylated portion comprises 10 to 50 percent of a total surface area of the functionalized surface.

Aspect 7 provides the functionalized nanoscale diamond of any one of Aspects 1-6, wherein the hydroxylated portion comprises 20 to 40 percent of a total surface area of the functionalized surface.

Aspect 8 provides a method of making the functionalized nanoscale diamond of any one of Aspects 1-7, the method comprising contacting a nanoscale diamond with a brominating agent to form the functionalized nanoscale diamond.

Aspect 9 provides the method of Aspect 8, wherein the brominating agent comprises SOBr₂, thionyl bromide, or a mixture thereof.

Aspect 10 provides the method of any one of Aspects 8 or 9, further comprising making the nanoscale diamond.

Aspect 11 provides the method of Aspect 10, wherein making the nanoscale diamond comprises milling a diamond.

Aspect 12 provides the method of Aspect 11, wherein milling the diamond comprises ball-milling.

Aspect 13 provides the method of any one of Aspects 8-12, comprising oxidizing the surface of the diamond prior to contacting the nanoscale diamond with the brominating agent.

Aspect 14 provides the method of any one of Aspects 8-13, further comprising contacting the nanoscale diamond with a catalyst.

Aspect 15 provides the method of Aspect 14, wherein the catalyst comprises pyridine.

Aspect 16 provides the method of any one of Aspects 8-15, wherein the method is free of contacting the nanoscale diamond with a catalyst.

Aspect 17 provides an aminated nanoscale diamond comprising a functionalized surface comprising:

an aminated portion.

Aspect 18 provides the aminated nanoscale diamond of Aspect 17, wherein the aminated portion comprises a primary amine a secondary amine, a tertiary amine, or a mixture thereof.

Aspect 19 provides the aminated nanoscale diamond of any one of Aspects 17 or 18, wherein the aminated portion comprises an alkylamine, an arylamine, an alkylarylamine, a dialkylamine, a diarylamine, an aralkylamine, a heterocyclylamine, a dialkylarylamine, an alkyldiarylamine, or a mixture thereof.

Aspect 20 provides the aminated nanoscale diamond of any one of Aspects 17-19, wherein the aminated portion comprises at least two different amines.

Aspect 21 provides the aminated nanoscale diamond of any one of Aspects 17-20, wherein the aminated portion comprises 10 to 50 percent of a total surface area of the functionalized surface.

Aspect 22 provides the aminated nanoscale diamond of any one of Aspects 17-21, wherein the aminated portion comprises 20 to 40 percent of a total surface area of the functionalized surface.

Aspect 23 provides a method of making the aminated nanoscale diamond of any one of Aspects 17-22, the method comprising contacting the functionalized nanoscale diamond of any one of Aspects 1-22, with an amine source.

Aspect 24 provides the method of making the aminated nanoscale diamond of Aspect 23, wherein the amine source comprises NH₃·THF.

Aspect 25 provides the method of making the aminated nanoscale diamond of any one of Aspects 23 or 24, wherein contacting the functionalized nanoscale diamond with an amine source occurs at a temperature in a range of from about 20° C. to 50° C.

Aspect 26 provides the method of making the aminated nanoscale diamond of any one of Aspects 23-25, wherein contacting the nanoscale diamond with an amine source occurs at a temperature in a range of from about 20° C. to 30° C.

Aspect 27 provides the method of making the aminated nanoscale diamond of any one of Aspects 23-26, wherein contacting the nanoscale diamond with an amine source is free of using a catalyst.

Aspect 28 provides a method of using the aminated nanoscale diamond of any one of Aspects 17-27, the method comprising:

disposing the aminated nanoscale diamond in an environment;

selectively alternating a spin-state of a nitrogen-vacancy center of the aminated nanoscale diamond; and

receiving output.

Aspect 29 provides the method of Aspect 28, wherein the method comprises an action potential measurement system, an optically detected magnetic resonance system, or a combination thereof.

Aspect 30 provides the method of Aspect 29, wherein the action potential measurement system provides output relating to neuron activity, an electric field, a pH level, or a combination thereof.

What is claimed is:

1. A functionalized nanoscale diamond comprising:
a functionalized surface comprising:
a brominated portion; and
a hydroxylated portion.

2. The functionalized nanoscale diamond of claim 1, wherein the brominated portion comprises a plurality of bromine atoms bonded to carbon atoms at the surface of the functionalized nanoscale diamond.

3. The functionalized nanoscale diamond of claim 1, wherein the hydroxylated portion comprises a plurality of hydroxy groups bonded to carbon atoms at the surface of the functionalized nanoscale diamond.

4. The functionalized nanoscale diamond of claim 1, wherein the brominated portion comprises 10 to 50 percent of a total surface area of the functionalized surface.

5. The functionalized nanoscale diamond of claim 1, wherein the brominated portion comprises 20 to 40 percent of a total surface area of the functionalized surface.

6. The functionalized nanoscale diamond of claim 1, wherein the hydroxylated portion comprises 10 to 50 percent of a total surface area of the functionalized surface.

7. The functionalized nanoscale diamond of claim 1, wherein the hydroxylated portion comprises 20 to 40 percent of a total surface area of the functionalized surface.

8. A method of making the functionalized nanoscale diamond of claim 1, the method comprising contacting a nanoscale diamond with a brominating agent to form the functionalized nanoscale diamond.

9. The method of claim 8, wherein the brominating agent comprises SOBr₂, thionyl bromide, or a mixture thereof.

10. The method of claim 8, further comprising making the nanoscale diamond.

11. The method of claim 10, wherein making the nanoscale diamond comprises milling a diamond.

12. The method of claim 11, wherein milling the diamond comprises ball-milling.

13. The method of claim 8, comprising oxidizing the surface of the nanoscale diamond prior to contacting the nanoscale diamond with the brominating agent.

14. The method of claim 8, further comprising contacting the nanoscale diamond with a catalyst.

15. The method of claim 14, wherein the catalyst comprises pyridine.

16. The method of claim 8, wherein the method is free of contacting the nanoscale diamond with a catalyst.

17. An aminated nanoscale diamond comprising a functionalized surface comprising:
an aminated portion.

18. The aminated nanoscale diamond of claim 17, wherein the aminated portion comprises a primary amine a secondary amine, a tertiary amine, or a mixture thereof.

19. The aminated nanoscale diamond of claim 17, wherein the aminated portion comprises an alkylamine, an arylamine, an alkylarylamine, a dialkylamine, a diarylamine, an aralkylamine, a heterocyclylamine, a dialkylarylamine, an alkyldiarylamine, or a mixture thereof.

20. The aminated nanoscale diamond of claim 17, wherein the aminated portion comprises at least two different amines.
